(19) United States
(12) Patent Application Publication
(10) Pub. No.: US 2007/0106565 A1
(43) Pub. Date: May 10, 2007

(54) Method For Using A Communications Network To Define A Product, And The Ordering Thereof By A Consumer

(76) Inventor: Pedro Tropa Coelho, Berkeley, CA (US)

Correspondence Address: Pedro Coelho, PO Box 7538, Berkeley, CA, 94707, US

(21) Appl. No.: 11/530,912

(22) Filed: Sep. 12, 2006

Related U.S. Application Data
(60) Provisional application No. 60/735,527, filed on Nov. 7, 2005.

(51) Int. Cl. G06Q 30/00

(52) U.S. Cl. 705/26

(57) ABSTRACT

Method is described that enables a creator user, such as a consumer, to define a product over a communications network making use of a client device to customize a product description in relation to available retailer information, and to customize, and/or cause the assignment of a customized, product identifier to said product description, and by causing the resulting product information to be stored, and made available, through a server system so as to enable creator users, or other consumers, to further define products and/or to place product order(s) at selected retail location(s). Retailer users may use a client device to define retailer information for near real time use by system users. Retail users may use a client device to input information to the system and, in turn, have the system send back information to allow providing, near real time, information regarding, identification, manufacture and/or sale of, product order(s).

### CROSS-REFERENCE TO RELATED APPLICATIONS

The present Utility patent application claims priority benefit of the U.S. provisional application for patent No. 60/735,527 filed on Nov. 7, 2005 under 35 U.S.C. 119(e). The contents of this related provisional application are incorporated herein by reference.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention is directed to information systems and methods wherein a consumer places one or more orders for a product defined using a communication network. In particular, the present invention relates to systems and methods wherein a consumer is allowed to place an order at a retailer for a product whose product identifier and product description information were customized using a communication network.

### BACKGROUND OF THE INVENTION

To date, retail food products are typically defined by retailers and listed as offerings in a menu with each entry identified by a name also typically defined or selected by the retailer. Food menu entries are typically listed for yes/no selection with limited information listed regarding customization possibilities, or allowed upon request, by consumers. While menu entries are normally manufactured with a more or less complex combination of a food retailer s resources, such processes and materials are not typically itemized, identified and organized so as to make them available for selection, customization and combination into a product by consumers interested in defining their own customized food products. Another disadvantage of listing offerings in typical static or dynamic food menus displayed virtually online or physically on-location is that they do not allow retailers to directly display their retail location(s) full inventory of food ingredients and packaging plus manufacturing process skills, all of which are resources usually available for use in the manufacture of food at any given location(s) so that such resources are not made available to consumers interested in customization and in avoiding, for example, the repetitive communication of preferences upon repeat order placement of a customized product.

Typically, upon order placement at a food retail location, a consumer will recite choices read from the food menu entries defined by a retailer. Moreover, if any customization is desired, a consumer will typically have to voice any customization preferences in sufficient detail to allow proper manufacture of the product by the retailer. Presently, some stores such as Starbucks® retail locations resort to writing customization notes and customer requests by checking boxes printed on the side of paper cups upon order placement, for communication of information to personnel actually manufacturing the product. In other stores, upon order placement, the order and any customization information may be inputted in real time into a POS terminal, and such data be automatically routed to, for example, without limitation, an output device for automated preparation, or for interpretation by manufacturing personnel for product preparation, such as, without limitation, an LCD display for reading by manufacturing personnel. Still, food order customization by consumers traditionally requires the repeated verbal communication of preferences by consumer in a process that is time consuming, error prone and labor intensive. Moreover, the higher the complexity level of product customization by consumers upon order placement, the more acute such customization problems may become.

Due in part to limitations of traditional physical menus, such as physical size and/or number of entries and text font size, and to the time consuming demands imposed on a typical consumers understanding of, and selection from, food menus upon order placement, menus traditionally list a relatively limited number of menu entries. The limited nature of menu entries is especially evident when observed in relation to all possible permutations normally found within a retailer s usually available manufacturing process and material resources. According to Business Week, Jun. 27, 2005, at last count Starbucks® had 20,000 possible permutations of drink combinations in their usually available inventory of resources. However, Starbucks® retail location menus, from where most consumer choices are typically made, contain a few dozen entries at the most. In fact, the same press article makes reference to the retailer's seasonal changes to menus, indicating that when interested in introducing new entries, retailers are typically limited to replacing existing menu entries. Therefore, the number of entries on a menu can be very small in relation to the number of combinations theoretically possible from using all the food ingredients, packaging and manufacturing processes available. In a competitive business environment, the difficulty to physically accommodate an expansive number of menu choices by retailers unable to increase their typical-menu-listed offerings to expand their business dictates the loss of a potential competitive advantage that could be found in aspects such as a retailer s potential increase in virtual product offerings, improved inventory management and turnaround, and increased consumer satisfaction and loyalty.

The limited number of entries in a typical food menu is also due in part to the risk of confusing a consumer or delaying the time required by consumers to place an order at a retail location. Moreover, several other consumers may stand in line waiting for someone else's order placement. This is a personally frustrating experience for both those ordering and those waiting, and so certainly not conducive to customer satisfaction. In fact, to date, the time consuming nature of order placement by consumers is one of the toughest profit bottlenecks identified in retailers such as fast food retailers Starbucks® and McDonalds®. If further customization of a product listed on the menu is desired by the consumer, the discovery of potentially necessary retailer resources information, the decision making and the communication of choices, can be time consuming, error prone and labor intensive. Moreover, absent an extraordinary arrangement between retailer and consumer, order placement of multiple products or menu entry offerings at once by a consumer also traditionally requires that each product choice be listed separately by consumer, a process that can again be time consuming, error prone and labor intensive.

Moreover, if offered by retailers, the persistent recording of a consumer's individual preferences will traditionally involve time consuming, error prone and labor intensive tasks such as conveying all customization alternatives offered by a retailer, recording a customer's choices, and locating and retrieving such records for food manufacture upon order placement or for further record editing. The difficulty of creating and keeping a readily accessible record of individual consumer preferences further increases when such preferences are of an higher level of complexity, or to be made accessible at more than one retail location.

A need therefore exists for a system that allows retailers to expose their usually available manufacturing processes and materials resources at selected retail location(s), so as to allow their controlled use in the definition of retail food menu products online—including the customization of both the product identifier and the product description information aspects of a retail food product—by independent consumers, and in the real time identification, manufacture and/or sale of a defined product by retail operators with access to such defined product information and to the required, or alternative, actionable resources, at retail location(s) located potentially anywhere.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is block diagram that illustrates an overview of an exemplary system in which a consumer can place orders for a product defined using a communication network, in accordance with an embodiment of the present invention. FIG. 1B shows exemplary implementation details of the system of FIG. 1A;

FIG. 2 is a block schematic diagram of an exemplary custom system device, in accordance with an embodiment of the present invention;

FIG. 3 is a block schematic diagram of an exemplary retailer device, in accordance with an embodiment of the present invention;

FIG. 4 is a block schematic diagram of an exemplary creator device, in accordance with an embodiment of the present invention;

FIG. 5 is a block schematic diagram of an exemplary retail device, in accordance with an embodiment of the present invention;

FIG. 6 is a tabular representation of a portion of an exemplary retailer database that may be stored in the custom system device, in accordance with an embodiment of the present invention;

FIG. 7 is a tabular representation of a portion of an exemplary process database that may be stored in the custom system device, in accordance with an embodiment of the present invention;

FIG. 8 is a tabular representation of a portion of an exemplary ingredient database that may be stored in the custom system device, in accordance with an embodiment of the present invention;

FIG. 9 is a tabular representation of a portion of an exemplary packaging database that may be stored in the custom system device, in accordance with an embodiment of the present invention;

FIG. 10 is a tabular representation of a portion of an exemplary user database that may be stored in the custom system device, in accordance with an embodiment of the present invention;

FIG. 11 is a tabular representation of a portion of an exemplary product database that may be stored in the custom system device, in accordance with an embodiment of the present invention;

FIG. 12 is a flow chart illustrating an exemplary method in which a consumer places a product order with a retailer for a product customized using a communication network, in accordance with an embodiment of the present invention; and

FIG. 13 is a flow chart illustrating an exemplary method in which a consumer places a product order with a retailer for a product customized using a communication network, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a variety of techniques are described for using a communications network for defining a product, and ordering thereof by a consumer.

An aspect of the present invention is to allow system users such as a consumer to define products over a communications network (e.g., the Internet) by causing the customization of both the product identifier and the product description elements of a product. A related aspect of the latter element is allowing participating retailers to expose their inventory of manufacturing processes and materials usually available at selected retail location(s) so as to allow their use in the definition of customized products via a communications network. A related aspect of the present invention is to allow participating retailers or other entities to determine the rules and degree of freedom according to which both elements may be customized in a product that can be ordered at one or more retail location(s) where the product may be identified and sold by participating retailers or other retailers. A related aspect of the present invention is to allow consumers to both independently define a product through the system, as creator users, and thereafter place order(s) for such product at selected retail location(s), as consumers. A related aspect of the present invention is to allow consumers other than the product's original creator to place orders for said product. A related aspect of the present invention is to allow for a, near real time, menu display of creator-users-defined products for product information access and product order selection by consumers at retail location(s) located virtually anywhere and associated with any number of retailers.

Another aspect of the present invention is to allow the placement of repeated orders for a product, defined online by a creator user such as a consumer, by a consumer's singular communication of a valid product identifier to a selected retail operator. A related aspect of this invention is to allow retail location(s) the singular input of a valid product identifier to a system for retrieval, potentially in real time with its customization, of sufficient standardized information to allow the frequent identification, manufacture and sale of a product maybe never before provided by said retailer(s). A related aspect of the present invention is to allow selected retailers to identify, manufacture and sell, previously unknown and never before manufactured product(s), upon communication by consumer of a singular customized product identifier.

Another aspect of the present invention is to allow system users such as retailers and consumers to benefit from the timesaving and error-proofing advantages of the present invention. For example, without limitation, complex food orders, such as, but not limited to, a meal for large numbers of people or a highly customized product, can be ordered by a consumer's singular communication of a product identifier to a retailer. Another aspect is that the placement of a potentially complex food order with a customized product identifier may benefit many system users in different ways. For example, without limitation, speech impaired individuals may benefit greatly from the ability to use faster and simpler communication, verbal or automated.

Another aspect of the present invention is to allow retailers to keep a record of individual, or group, user information including consumer preferences as to preparation of food products readily accessible in real time from a virtually unlimited number of retail location(s) connected to a communication network. A related aspect of this invention is to allow the accurate and consistent recording and costing of customized consumer preferences by retailers. Another aspect of the present invention is to allow the development of new possibilities for business-consumer communication and marketing. For instance, without limitation, the desire to create customized recipes and meals can drive users to a Website online, therefore, allowing retailers to expose more potential consumers to their offerings, with dynamic and potentially user-customized Web experiences, and creating opportunities for retailers to increase their market knowledge and customer preferences. An aspect of some embodiments may be a potential user registration process that could allow for the collection of further data, and the further development of customized marketing relationships with potential customers. Moreover, the possibility for and ease of customization and the convenience of customized product order placement allowed by particular embodiments of the present invention can increase consumer loyalty and overall satisfaction. A related aspect of the present invention is to allow system users to have access to increased education regarding retailer offerings. For example, without limitation, virtually unlimited virtual space can be made available online to convey up to date real time information to educate users about offerings and related information, such as nutritional or user health related information. A potential user registration may further the collection of user data regarding, for instance, without limitation, user's medical history and to cross reference such information with retailer information stored in the system to, for instance, without limitation, warn a diabetic user of a product's sugar(s) type(s) and amount(s).

A further aspect of the present invention is to allow retailers such as participating retailers, and others, the potential value and business benefits that can be derived from tapping into the creative power of consumers and other entities interested in the independent definition of products that can thereafter be made available by said, or other independent retailers at selected retail location(s). A related aspect of this invention is to allow the potential creation of markets such as, for example, without limitation, where creator users may exchange product definitions for a value, or be rewarded with something of value, for example, for sales volume or other aspects of each of their product's use through the system; or where retailers, participating or independent, may be granted access to selected system information and functionality, for example, as retail users, freely or with consideration given for value. A further aspect of this invention is to allow the application of further product manufacture and/or sale automation systems, both of which are herein facilitated by the participating retailer(s)' usually available manufacturing resources and inventory data set(s) standardization, normalization, and modeling into information stored in a relational database server system so as to permit further systems integration with available retailer(s)' standard point of sale systems and automated manufacturing systems, to further increase the time-saving, error-proofing and other useful aspects of present invention.

Means and Steps are also provided for achieving some or all of the various functions described above.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Exemplary implementations of the present embodiment, and alternative embodiments, of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognized a multiplicity of alternate and suitable approaches, depending upon the needs of the particular application, to implement the functionality of any given detail described herein, beyond the particular implementation choices in the following embodiment described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

An embodiment of the present invention will next be described that addresses information systems and methods wherein a consumer places orders for a product defined using a communications network. In particular, the present invention relates to systems and methods wherein a consumer is allowed to place an order at a retailer for a product whose identifier and description information were customized using a communications network. While the preferred embodiments of the present invention are herein described in relation to the food retail industry, those skilled in the art in light of the present teaching will recognize alternate embodiments that may use the aspects of the preferred embodiment's approach to the near real time identification, manufacture and sale of products defined by consumers in other retail industries.

As used herein, a “retailer” may be any entity with one or more retail location(s) willing and able to provide information regarding, identify, manufacture and/or sell, a product defined through custom system device 200 to a consumer. For example, without limitation, in the retail food industry, a retailer might be a single or other set of retail location(s) such as a chain, such as, but not limited to, restaurants, coffee houses, pizza parlors, smoothie houses, food bars, food shops, supermarkets, cruise boats, trains or airplane food services. As used herein, food is meant to include singular or combined forms of edible substances such as, but not limited to, natural or artificial, processed or raw, liquid and/or solid food ingredients, recipes and formulas, such as food ingredients, beverages, meals, condiments, dietary supplements, and the like. As used herein, a “participating retailer” is a retailer with retailer information made available through the system to selected system users, such as, for example, retail location(s), creator users and retail users, as standardized elements in product definition through the custom system device 200 and in product identification, manufacture and/or sale by selected system users.

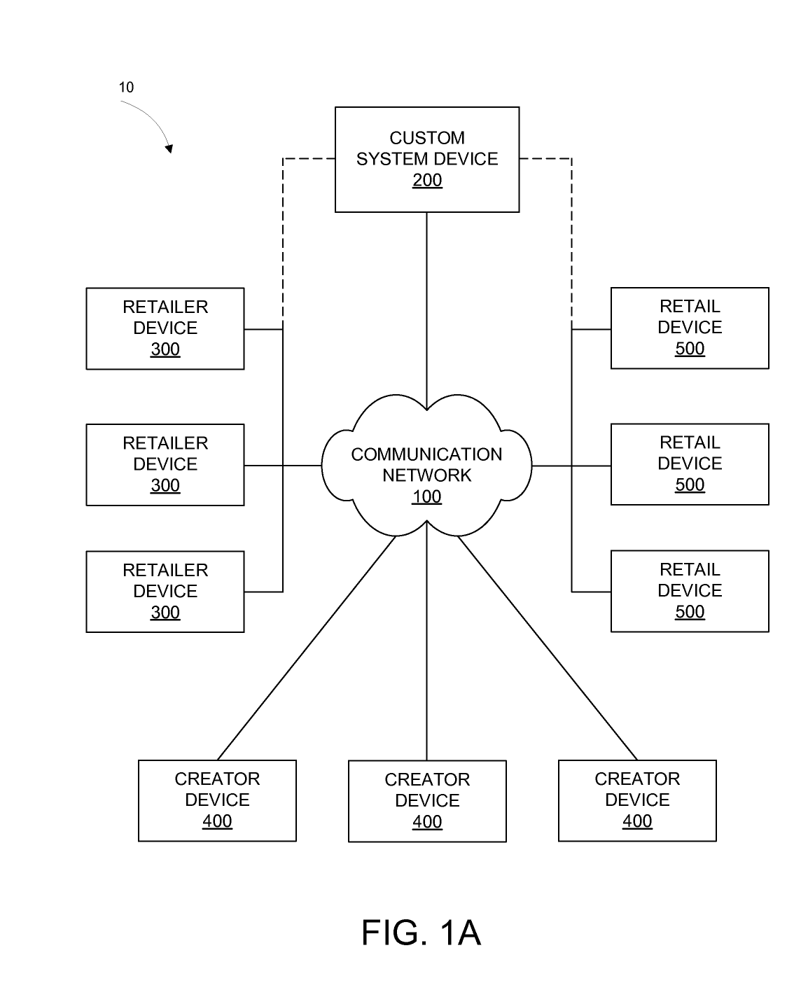

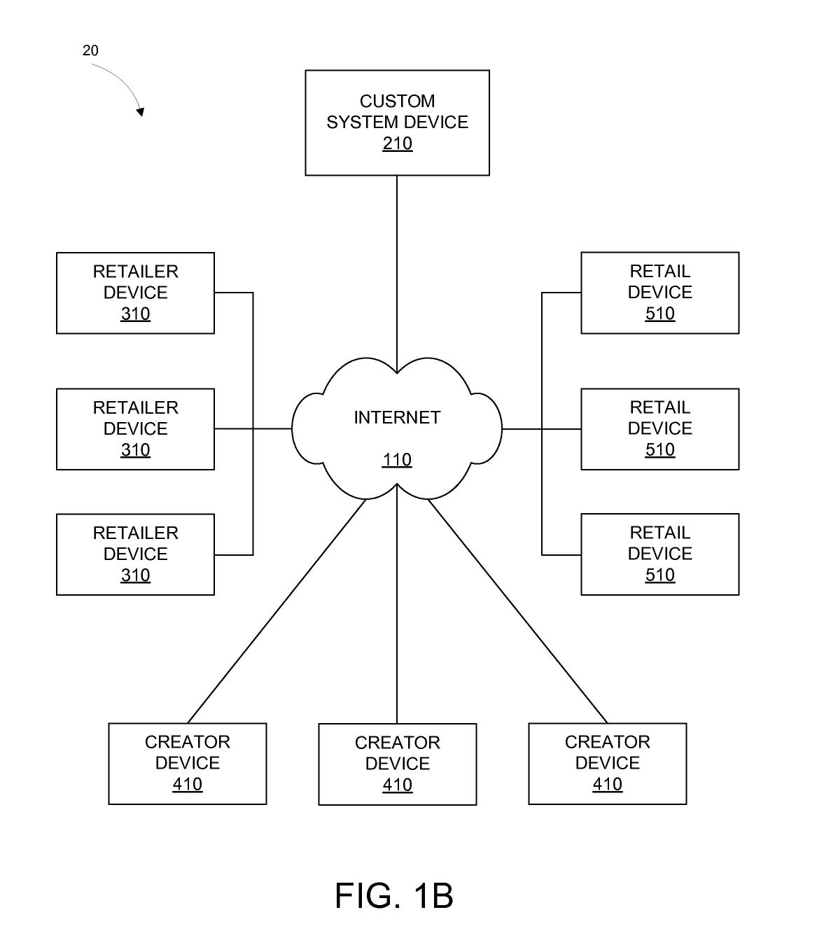

FIGS. 1A and 1B are block diagram overviews of exemplary systems in which a consumer can place orders for a product defined using a communications network, in accordance with an embodiment of the present invention. FIG. 1A is a block diagram overview of a system 10 according to one embodiment of the present invention. System 10 is comprised of a number of client devices including, but not limited to, retailer devices 300, creator devices 400 and retail devices 500 coupled to a custom system device 200 through a communication network 100. The devices may be, for example, without limitation, Personal Computers (PCs), Personal Digital Assistants (PDAs), Smart Phones, wired or wireless telephones, kiosks, Automated Teller Machines (ATMs), watches, and other client devices enabled to communicate with communication network 100, or any other appropriate communication device.

Communication network 100 may be, for example, without limitation, a Local Area Network (LAN), a Wide Area Network (WAN), a wireless network, a Public Switched Telephone Network (PSTN), or an Internet Protocol (IP) network such as, but not limited to, the Internet, an intranet or an extranet.

According to the present embodiment, custom system device 200 communicates with retailer device 300 through communication network 100 to at a minimum receive “retailer information” regarding a participating retailer. In an alternative embodiment, the function of retailer device 300 in the custom system may be replaced or complemented by the data import of retailer information to custom system device 200 from a data source other than retailer device 300, such as, without limitation, a data storage device such as an external hard-drive, linked via a communication network or data channel, locally or remotely, to retailer device 300.

As used herein, retailer information is a set of standardized information defined through the custom system device 200 by a participating retailer, and comprises two standardized information sets: a set of one or more “retail location(s)” (herein, where, or amongst which, a product may be identified, manufactured and sold, potentially in real time with said product definition and/or with product order placement at participating retailers and/or at other authorized independent retailers) and at least one set of “retailer items” information each including a set of standardized processes and standardized materials. In present embodiment's exemplary implementations, the “materials” data is further modeled and stored in one or more data set(s) with standardized ingredient items and standardized packaging items, and other related standardized parameters, usually available for use in the identification, manufacture and/or sale of products at retail location(s) with retailer items compatible with said product's description. A “product” may be herein understood to be a food product or a “food menu product”. However, those skilled in the art will recognize that a product defined through custom system device 200 may be almost any retail product type such as, but not limited to, perfumes, cosmetics, floral arrangements, and other retail industries. The typical inventory and manufacturing resources usually available at a food retail location consist of readily available information that can be modeled for digital representation and machine processing into, for example, without limitation, a set of database records. For example, without limitation, a product s manufacture can be described in a virtually unlimited number of step-by-step instructions represented in a timeline of sequential or parallel events related to creator-user-selection of participating-retailer-defined food manufacturing retailer items. Such manufacturing steps can be modeled for digital data representation and machine processing into, for example, without limitation, a set of database records. In present embodiment, usually available manufacturing processes and materials, product retailer items, are standardized, normalized and modeled into three categories, processes, ingredients and packaging, related to at least one participating retailer. Such retailer items are to be made available to selected system users for controlled “data access” (herein to be understood as the sending and receiving, post or get, pointing to, search, copy, edit and/or delete of, information made available through the system). A “product” may be herein understood to be a product information record set defined through the custom system device by creator users in relation to, potentially near real time, retailer information provided by one or more participating retailer(s).

As used herein, the term and references to “manufacture” or “manufacturing” mean the completion of a sequence of steps in order to ready a product for sale to a consumer upon product order and identification. This sequence of steps may very in complexity for example, without limitation, from very simple to very difficult, so that, an existing pre-packaged food product such as a specific Pepsi® product, may be identified in a product description corresponding to a valid product identifier such as, for example, without limitation, “Peter911”, or, in a more complex manufacture, as in example described herein below in regards to the product identifier “MYLATTE13”, or, in alternative embodiments, multiple products may be identified by a single product identifier corresponding to more than one valid product description.

As used herein, the term “sale” means the providing of a manufactured product order by one retail location to a consumer. However, upon order placement, the sale and manufacturing steps may be completed, by one, or distributed over several, retail location(s), and in any order possible, so as to achieve, potentially near real time, “product order” identification, manufacture and delivery to consumer. Providing the manufactured product to a consumer, may require the successful completion of sale steps, such as, but not limited to, order placement, retail handling, and payment by consumer or vendee to retailer or vendor. As used herein, the term “consumer” means system users placing a request for information regarding, and/or a product order for identification, manufacture and/or sale of a product.

In the present embodiment, custom system device 200 communicates with creator device 400 through communication network 100 to at a minimum send retailer information and receive product information. “Product information” can be represented in a variety of ways, such as, but not limited to, an itemized list of manufacturing steps with reference to retailer information in a printout, display or expression, a product identifier in a printout, display or expression, a bar code, a binary data file, to descriptive words or phrases, numerals, images, graphics, colors, sounds, biometric identifiers, etc.

As used herein, the “product information” for a product comprises two sets of standardized information, the “product identifier” and the “product description” that together herein constitute a “product definition”. In present invention, a product defined through custom system device 200 may be customized, by a creator user, as to both its product description and the corresponding product identifier aspects, so that two different product identifiers may in fact correspond to a similar, or equivalent, product description, and be truly unique only in their system identification.

As used herein, the “product description” consists of a product's standardized manufacturing timeline specifications information as defined in reference to one or more retailer items set(s), through custom system device 200, in order to allow, the definition of a product by a creator user, and said product's subsequent, and potentially immediate and real time identification, manufacture and/or sale at retail location(s) upon order placement by consumer(s). A “valid product description” herein includes sufficient product information and related system information, such as, related retailer information set(s), product information set(s) and user information set(s), to allow independent retail location(s) to identify and provide information regarding, and manufacture and/or sell, a product defined through the custom system device 200 by an independent creator user.

It should be noted that a retailer may be able to provide near real time information, manufacture and/or sale of products defined through custom system device 200 in relation to one or more set(s) of retailer items, and to one or more participating retailers, and at one or more retail location(s) related to participating retailer(s) or as an independent retailer. A retailer providing information regarding, manufacture/and or sale of product(s) defined through custom system device 200 may be related to the participating retailer entity, or another participating or independent retailer entity. A product description may be alternatively understood and identified through the custom system in reference to different but compatible set(s) of retailer items. A product order placed with a single product identifier may prompt the identification for manufacture and/or sale of multiple products, and, in alternative embodiments, not herein described, a product description may be related to other product description record set(s) data, for example, without limitation, by reference to other available product identifier(s) and corresponding product description(s) defined through custom system device 200.

As used herein, “product identifier” information may be, for example without limitation, an unique alphanumeric sequence of digits, defined through custom system device 200. However, a product identifier may be anything capable of being uniquely identified to allow access to a corresponding valid product description for any given retail location to provide information regarding, manufacture and/or sell the product identified, such as, but not limited to descriptive words or phrases, text, numerals, images, graphics, colors, sounds, bar codes, binary files, biometric identifiers, or other symbols. A customized product identifier may be selected from options displayed by system 10 or be input by a system user to system 10 for validation through custom system device 200 for example without limitation, for control of the uniqueness of the identifier in relation to other product identifiers defined for a participating retailer, and for possible control of other factors, such as, but not limited to, the intelligibility of a product identifier, while still allowing users relative freedom, and the added satisfaction, in the definition of a customized valid product identifier. A “valid product identifier” is one that, at a minimum, allows the “identification”, and therefore the access, to a corresponding product description by selected system users and devices.

In the present embodiment, custom system device 200 communicates with retail device 500 through communication network 100 to at a minimum receive and send information regarding a product defined through the custom system. For example without limitation, information communicated to a retail location by a consumer upon order placement is received, and in turn real time product description information is sent back to retailer to allow the real time manufacture and/or sale of the product at a selected retail location. So, that for example, without limitation, consumers may place an order for a product by directly transmitting valid product identifier and/or product description information to selected retail location's retail operator for real time product identification, manufacture and/or sale. In some embodiments, retail device 500 can be further integrated with other peripheral devices and systems, such as, but not limited to, a standard point of sale system (POS) for more highly automated accounting practices and inventory management. In other embodiments, other retail location's automated informational, transactional and/or manufacturing systems could be linked by a data channel and more or less integrated implementation of system functions.

In addition to retailer information and product information, custom system device 200 may include other information, such as, but not limited to, “user information” in preferred embodiments. User information may include, without limitation, identification and contact information for selected system users. As used herein, the term “user” includes not only a single individual but also a community of individuals, such as, but not limited to, the individuals who may access some element of the system 10 under a particular account number including, but not limited to individuals, communities such as, but not limited to legal entities, business, sport, or consumer associations, virtual communities, issue-related affiliated groups such as health-issues-related individuals such as diabetics, and other groups of system users.

As noted by the dashed lines in FIG. 1A, although FIG. 1A shows custom system device 200 communicating with retailer device 300 through the same communication network 100 used to communicate with creator device 400 and with retail device 500. Those skilled in the art will recognize that, in alternative embodiments, the same communication network, or instead a different communication network may be used, for example, without limitation, a Local Area Network (LAN), a Wide Area Network (WAN), a wireless network, a Public Switched Telephone Network (PSTN), or an Internet Protocol (IP) network such as, but not limited to, the Internet, an intranet or an extranet. As further noted by the two dashed lines in FIG. 1A: in some embodiments, the communication network 100 linking the retailer device 300 to the custom system device 200 may be replaced or complemented, together with retailer device 300's role as a data storage and communication device, by a local or remote data upload of retailer information from an alternative retailer information data source via for example a digital data channel, such as a USB cable, USB interface or a serial cable, into custom system device 200. In alternative embodiments, the communication network linking the retail device 500 to the custom system device 200, may be replaced by an alternative database storage and communication device such as, without limitation, a hard-drive, a USB RAM or a CD-ROM, and an appropriate data channel such as, without limitation, a serial cable or USB cable connection linking to, and allowing, retail device 500 the sufficient data access to retailer information and product information originally defined through the custom system device and thereafter replicated in a database medium with a, potentially out of date, snapshot of at least some of said data to allow for said data access functions.

A more detailed description of the present embodiment is provided with respect to FIG. 1B. All definitions and functionality listed herein before in relation to system 10 and its devices, users and information, apply to present embodiment as described hereinafter in relation to system 20, shown in FIG. 1A. As before, a system 20 is comprised of a number of retailer devices 310, creator devices 410 and retail devices 510, such as, but not limited to, PCs executing browser application software, coupled to a custom system device 210, such as, but not limited to, a Web server, through an Internet 110. Although embodiments of the present invention are described with respect to information exchanged using a Web site, those skilled in the art, in light of the present teaching, will recognize that information may be exchanged via alternate methods, for example, without limitation, a telephone, a facsimile machine, e-mail, a Web TV interface, a cable network interface, or a wireless device such as, but not limited to, a smart phone or a wireless-enabled PDA. In some embodiments, information exchanged between system users and the custom system device 210, may use a Voice Response Unit (VRU) or Interactive VRU (IVRU). Examples of IVRUs include, without limitation, the Vision 3001 and the Insight IVR/Web from Interactive Voice Technologies, Corp. and the OmniVox for Windows NT from APEX Voice Communications. An IVRU lets a user of a Dual Tone Multi-Frequency (DTMF) tone generating telephone, also known as “push button” telephone, communicate with a computer. The DTMF signals received from a user's telephone are interpreted by an IVRU server, and the IVRU server may also communicate with the user by generating and transmitting voice or other audio signals, such as, but not limited to, a list of IVRU menu options related to custom system device 210 functions.

In further exemplary implementation of present embodiment described until now in relation to system 10 and custom system device 200, shown in FIG. 1A, the custom system device 210, shown in FIG. 1B, not only allows for the definition of system information “through” the custom system device, but also for the storage of such “system information” (in present embodiment, the retailer information, product information and user information) in normalized relational database record sets. Custom system device 210 provides for real time or other controlled availability of information stored in the custom system device to selected system users and devices. Real time computations can be said to have failed if they are not completed in the time-period after the event before the deadline relative to the event. Real time systems are typically those used where there is some issue of concurrent access, as herein, in keeping a number of connected devices, up to date with changing situations. The software that maintains and updates the custom system databases for synchronized use by system users is part of a real time system. Real time, or near real time, systems may operate to a latency of seconds. Violation of real time operation constraints results in degraded quality, but the system herein may continue to operate.

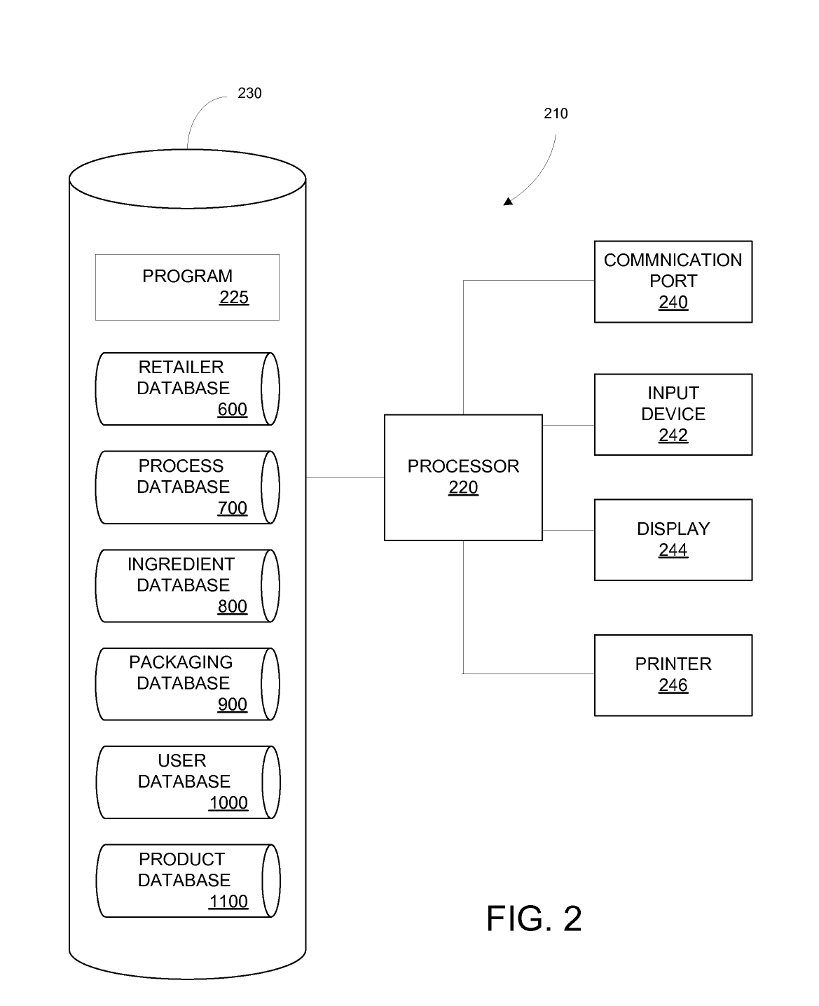

FIG. 2 is a block schematic diagram of an exemplary custom system device 210, in accordance with an embodiment of the present invention. Those skilled in the art, in light of the present teaching, will recognize that this embodiment is merely an illustration and that many other embodiments are possible in the present invention. For example, without limitation, different database models and locations, and different client and server number and locations, and different software user features and program locations are possible amongst many other embodiments of the present invention. Moreover, notwithstanding present embodiment being herein consistently described with reference to three separate client user devices (retailer device, creator device and retail device) and their respective client device functional users (retailer user, creator user and retail user), it should be obvious to anyone skilled in the art, in light of the present teaching, that a database-enabled Web-application s functionality, including that of its client user interface(s), can be distributed amongst a variable number of client device(s) and server(s), particular client device GUI(s), and users of said functionality.

Most PCs and many other client devices today run under an operating system that provides a graphical user interface (“GUI”) for accessing user applications such as Web-applications via, for example, without limitation, a browser application displaying Web page GUIs. Dynamic, Web-enabled, GUIs are used in preferred embodiments of the present invention. However, other, non-GUI, operating systems may be appropriate in alternate embodiments such as, but not limited to, command-line operating systems. Through an interface of windows, pull-down menus, toolbars and other “objects” displayed, GUI operating systems have simplified PCs and have rendered computer technology more user friendly by eliminating the need to memorize keyboard entry sequences. In addition, GUIs allow users to manipulate their data as they would physical entities. For example, without limitation, a window can represent a database and the contents of the window can represent the records of the database. The window can be opened, closed, or set aside on a desktop as if it were an actual object. The records of the database can be created, deleted, modified and arranged in a drag-and-let-go or a drag-and-drop fashion as if they also were physical objects. The database record entries can be entered through the manipulation of physical objects on screen, such as, without limitation, their number, position, size, color or other visual aspects. Common GUI operating systems that provide this object-oriented environment for personal computers are for example, without limitation, Microsoft Windows® operating systems, including, but not limited to, Windows CE for handheld wireless devices, Windows XP for PCs, and Windows NT for servers. Generally, a particular application program running on a GUI operating system presents information to a user through a window of a GUI by drawing images, graphics or text within the window region. The user, in turn, communicates with the application through a “GUI action”, for example, without limitation, by pointing at, and manipulating, graphical objects in the window with a pointer that is controlled by a hand-operated pointing device such as, but not limited to, a mouse, or by pressing buttons on a keyboard or mouse, or by issuing voice commands when interfacing with a voice recognition enabled device. As illustrated in examples above, a “GUI action” is herein understood to include both a device GUI's objects manipulation and other data input, by system users. Those skilled in the art, in light of the present teaching, will recognize that a user may interact with many alternative input and output devices such as, but not limited to, a keyboard, a mouse, a touch screen, a remote control, a microphone and speaker linked to a voice recognition system, monitor, or a Braille keyboard or Braille display.

FIG. 2 illustrates an embodiment of a custom system device 210 that is descriptive of the device shown in FIG. 1B wherein retailer information, product information, and user information, is stored locally at custom system device 210. Custom system device 210 comprises a processor 220, such as, but not limited to, one or more Pentium® processors, coupled to: a communication port 240 configured to communicate through a communication network (not shown in FIG. 2); an input device 242, such as, but not limited to, keyboard, mouse or touch screen; a display 244, such as but not limited to a monitor or a Braille display; and a printer 246. Communication port 240 may be used to communicate with, for example, without limitation, a plurality of retailer devices 310, a plurality of creator devices 410, and a plurality of retail devices 510.

In the present embodiment, the Web site may be hosted by a server at custom system device 210 or be hosted by a server coupled to custom system device 210. As known to those skilled in the art in light of the present teaching, the Web site may be dynamic, i.e., be able to change appearance after each request exchanged between server and client, and be generated with standard software and/or hardware technologies. For example, without limitation, in one embodiment, a dynamic Web site may be generated via a server running Microsoft® Internet Information Services Web server hosting a published Microsoft® Active Server Pages Web-application coded in, for example, without limitation, HTML, C, Java Script and ActiveX Data Objects, with access to a database management system running, for example, Microsoft® SQL Server.

In the present embodiment, processor 220 is also in communication with a data storage device 230. Data storage device 230 comprises an appropriate combination of magnetic, optical and/or semiconductor memory, and may include, without limitation, Random Access Memory (RAM), Read-Only Memory (ROM) and/or a hard disk. Processor 220 and storage device 230 may each be located entirely within single computers or other computing devices, linked to each other by a data channel or remote communication medium, such as, but not limited to, a serial port cable, telephone line or wireless frequency transceiver, or a combination thereof. In one embodiment, custom system device 210 may comprise one or more computers that are linked to a remote server computer system for maintaining databases.

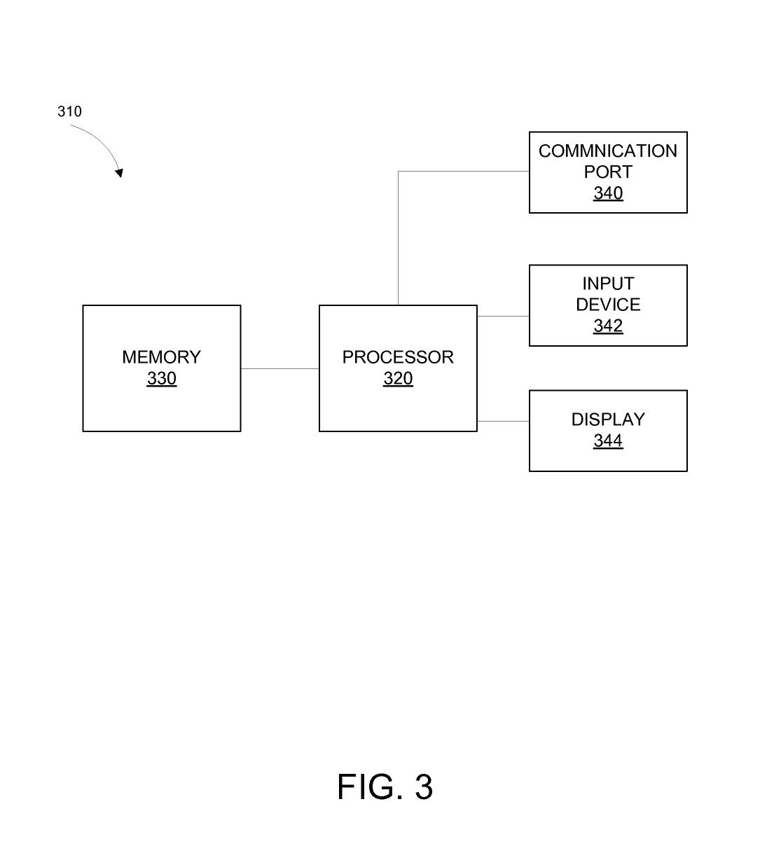

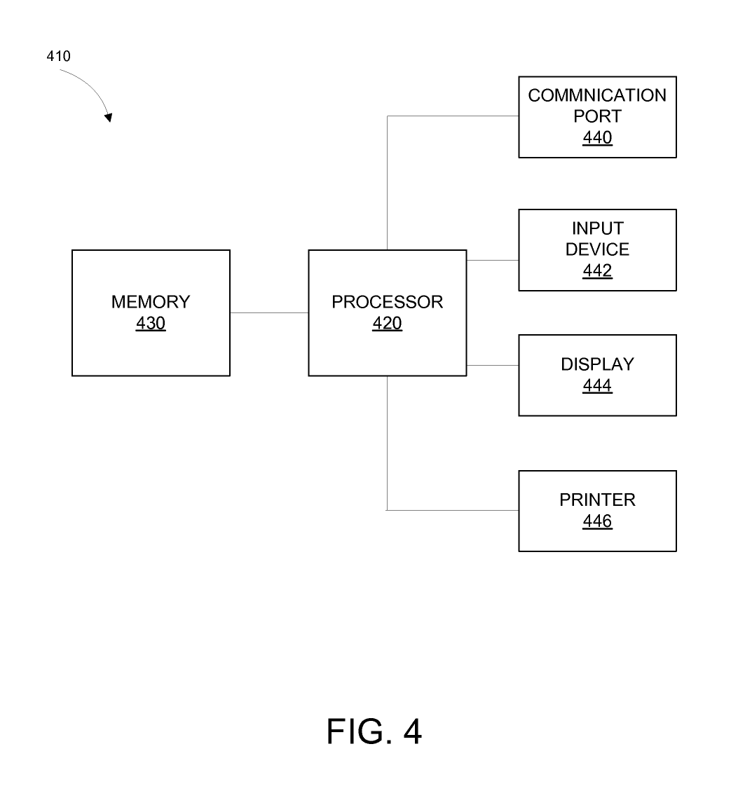

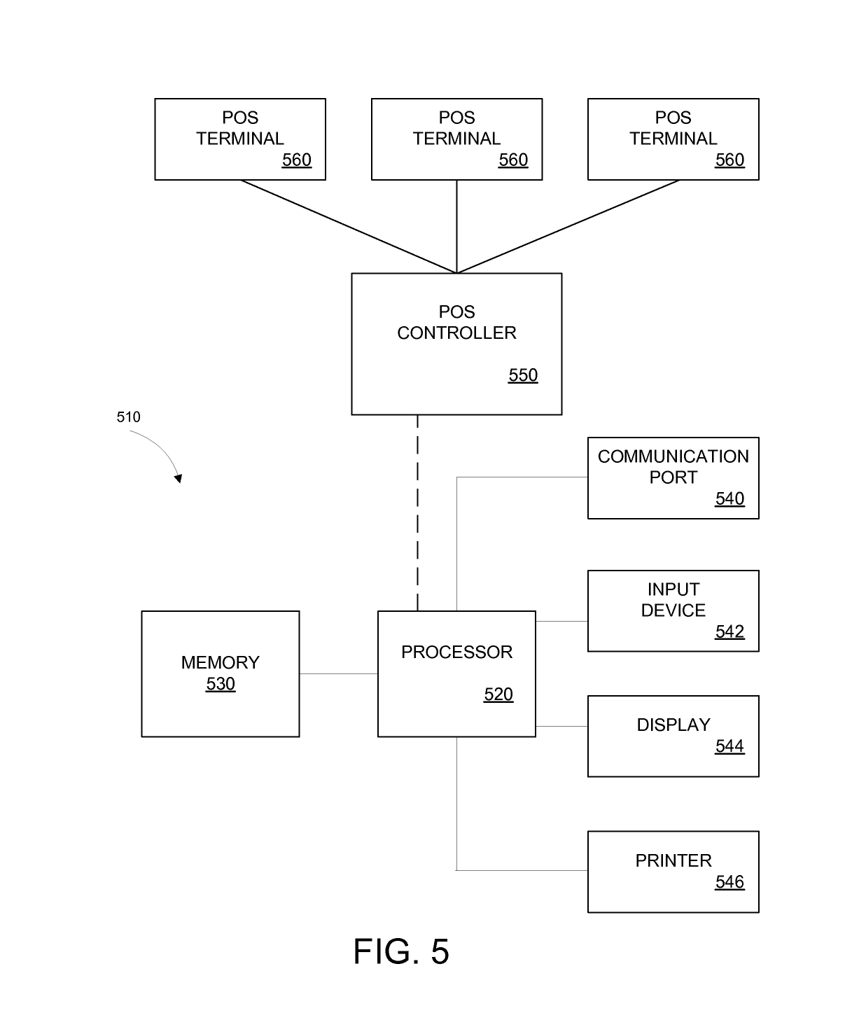

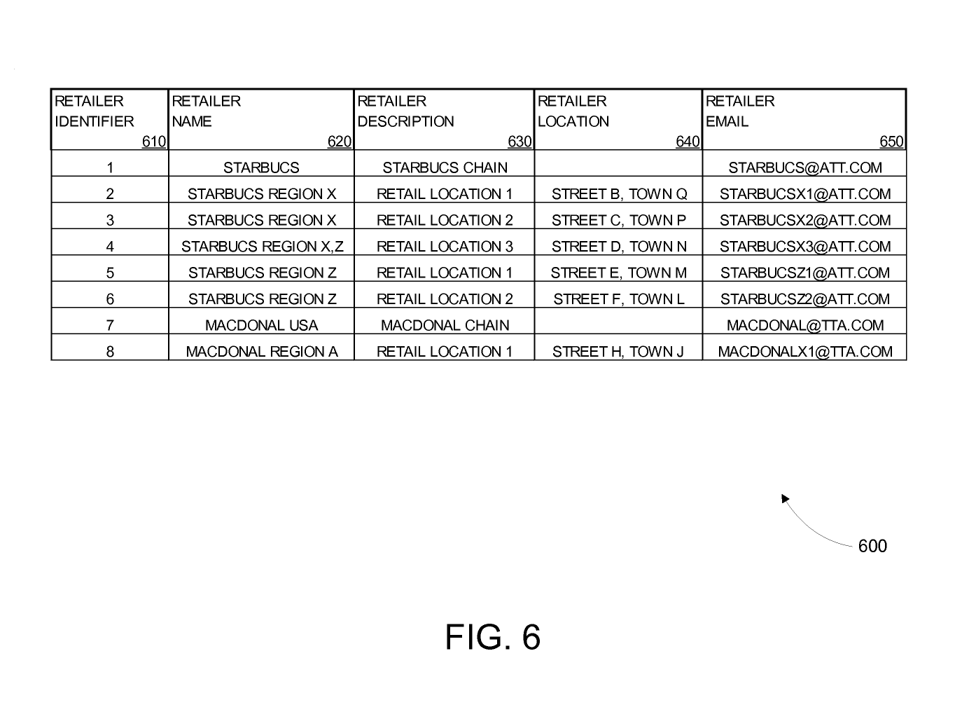

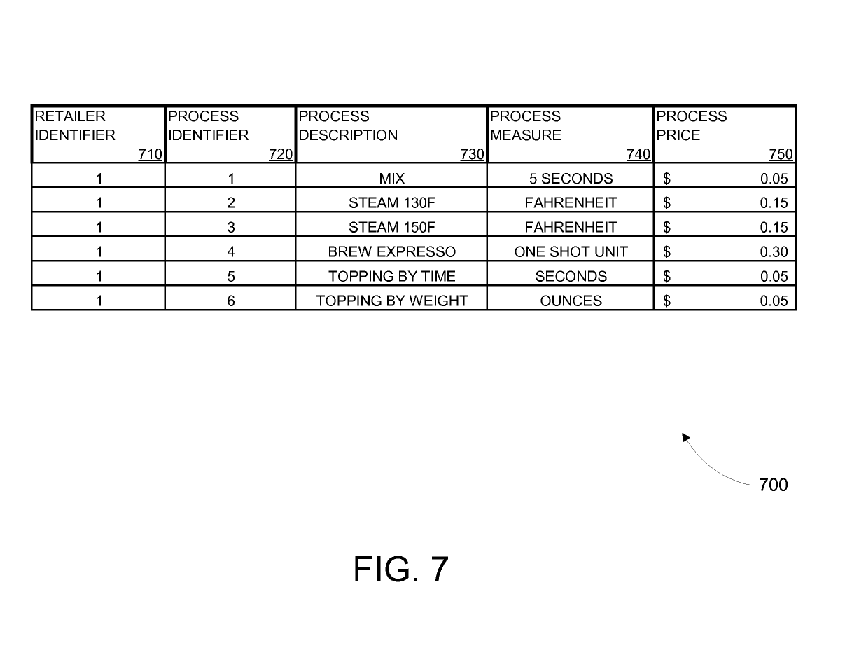

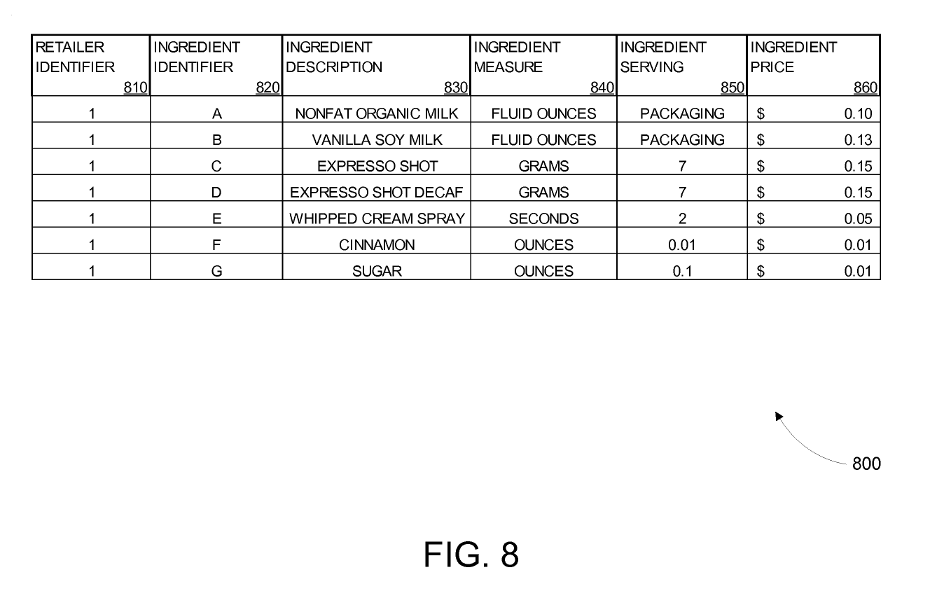

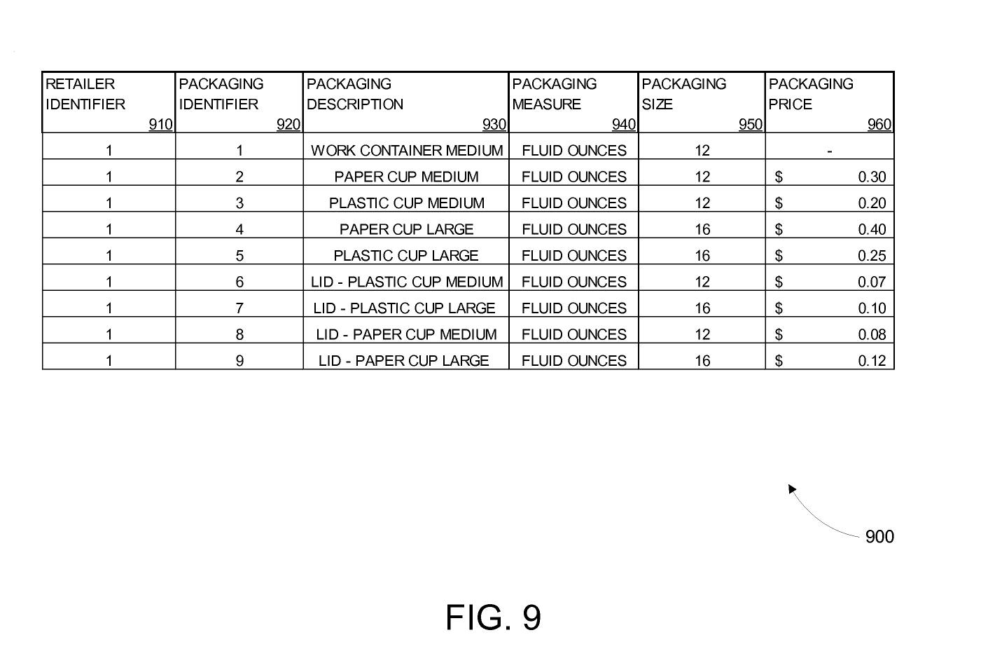

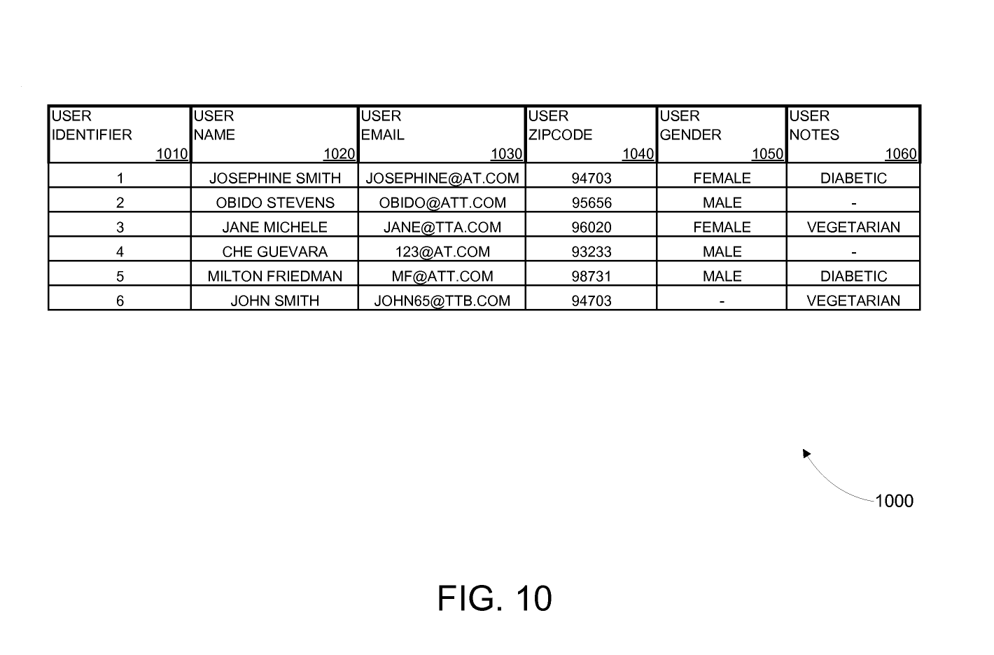

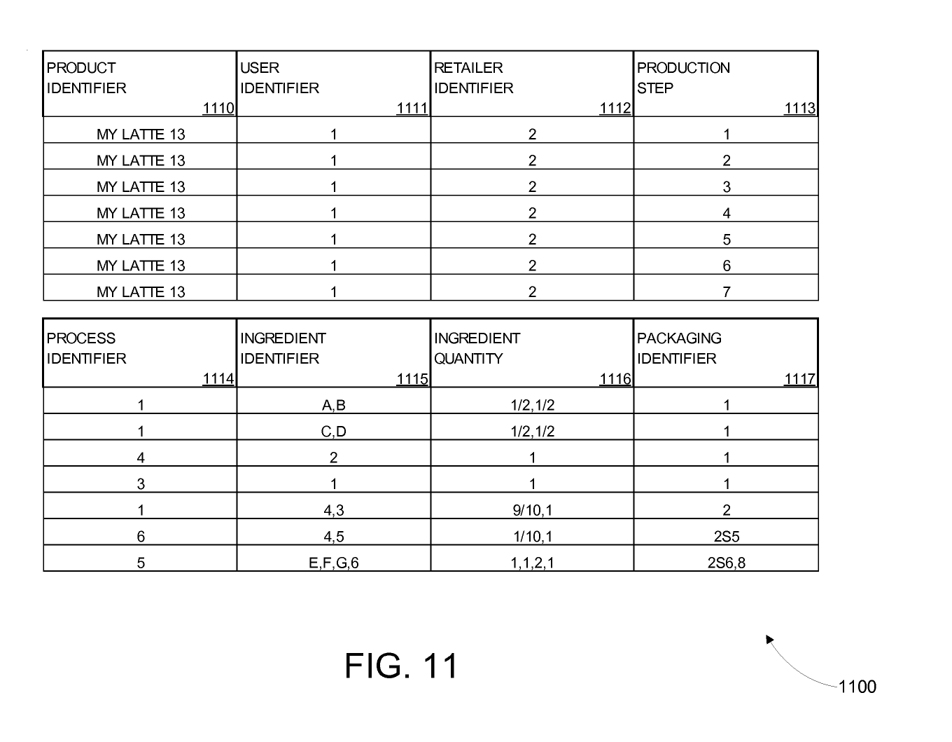

In the present embodiment, data storage device 230 stores a program 225 for controlling processor 220. Processor 220 performs instructions of program 225, and thereby operates in accordance with the present embodiment, and particularly in accordance with the methods described in detail herein. For example, without limitation, when information, such as retailer information, product information or other information, is received, custom system device 210 may store it in a database system for future controlled access to said information by selected system users, so that, for example, without limitation, a retailer user may access, view, search, select, copy, delete and generally edit retailer information, a creator user may access view, search, select, copy, product information and retailer information, and/or delete and generally edit creator user-authored product information, and a retail user may generally access, view, search, or otherwise make use of said product information including related retailer information for product identification, analysis(such as, for example, without limitation, product validation for availability at selected retail location(s)), manufacture and/or sale upon product order placement. As used herein, information may be accessed, or sent or received, by different methods such as, but not limited to, through custom system device 210 in communication with retailer device 310, shown in FIG. 3, or with creator device 410, shown in FIG. 4, or with retail device 510, shown in FIG. 5, or through a software application or module within custom system device 210 from another software application, module or any other source. Processor 220 may execute instructions to perform at least one function of the present embodiment. Program 225 may be stored in a compressed, uncompiled and/or encrypted format. Program 225 furthermore comprises program elements, such as, but not limited to, an operating system, a database management system and “device drivers” used by processor 220 to interface with peripheral devices and/or potentially integrated systems. Appropriate device drivers and other program elements are known to those skilled in the art and are not described in detail herein. As shown in FIG. 2, storage device 230 also stores, without limitation, a retailer database 600 (described in detail with respect to FIG. 6); a process database 700 (described in detail with respect to FIG. 7); an ingredient database 800 (described in detail with respect to FIG. 8); a packaging database 900 (described in detail with respect to FIG. 9); a user database 1000 (described in detail with respect to FIG. 10); and a product database 1100 (described in detail with respect to FIG. 11). The schematic illustrations and accompanying descriptions of the databases presented herein are exemplary, and any number of other database arrangements could be employed besides those suggested by the figures.

In the present embodiment, custom system device 210 shown in FIG. 2 allows a retailer user to interact with retailer device 310, shown in FIG. 3, to define participating retailer information, including, but not limited to, at least one set of retailer items and one retail location contact information, for, potentially near real time, use by system users, and to store such information in retailer database 600, process database 700, ingredient database 800 and packaging database 900, shown in FIGS. 6, 7, 8, and 9 respectively, of custom system device 210 using a communication network such as, but not limited to, the Internet. Custom system device 210 also allows a creator user to interact with creator device 410, shown in FIG. 4, to define products by causing the customization of a product identifier and product description product information record set, defined in terms of at least one set of retailer items and creator user input to the system 20, and to store such product information in product database 1100, using a communication network such as, but not limited to, the Internet. Custom system device 210 also allows a consumer to place an order for a product defined through the custom system device 210 by transmitting a valid product identifier and/or a product description to a retail operator at selected retail location(s). A further function of custom system device 210 is to allow a retail user to input a valid product identifier, for example, without limitation, supplied by a consumer for order placement, to system 20, shown in FIG. 1B, to, in turn, receive product description information from product database 1100 of custom system device 210, using a communication network such as, but not limited to, the Internet. In an alternative embodiment, a retail user may input other information, using a communication network, for example without limitation the Internet, such as, but not limited to, selected user information and/or product information, in order to verify the validity at a given retail location of a product description supplied for example without limitation by consumer upon order placement.

FIG. 3 is a block schematic diagram of an exemplary retailer device 310, in accordance with an embodiment of the present invention. Retailer device 310 comprises a processor 320 coupled to a communication port 340, an input device 342, such as, but not limited to, a keyboard, mouse or touch screen; and a display 344, such as, but not limited to, a monitor or a Braille display; and an optional printer not shown in FIG. 3. It should be noted that the printer is optional in the present embodiment because the retailer device's main function is one of data input and printer outputs are not particularly relevant. Processor 320 is also coupled to a memory 330 and may execute instructions to perform at least one function of the present embodiment.

In the present embodiment, a retailer user may use retailer device 310 to communicate with custom system device 210, shown in FIG. 2, through a communication network such as, but not limited to, the Internet. As used herein, a “retailer user” is a direct or indirect user of retailer device 310 for purposes of defining, new or existing, retailer information, record sets defined through, and stored in, the custom system device 210. A retailer user may use retailer device 310 to communicate with custom system device 210, shown in FIG. 2 through a communication network, for example, without limitation, the Internet. In some embodiments, a retailer user may sign-on to a Web site to interact with a GUI that allows users to define retailer information through custom system device 210, shown in FIG. 2, for storage therein. This may include, without limitation, structuring and populating retailer database 600, process database 700, ingredient database 800 and packaging database 900, shown in FIGS. 6, 7, 8, and 9, respectively, for access by system users, so as to allow, for example, without limitation, the definition of products based on real time retailer information.

FIG. 4 is a block schematic diagram of an exemplary creator device 410, in accordance with an embodiment of the present invention. Creator device 410 comprises a processor 420 coupled to a communication port 440, an input device 442, such as, but not limited to, a keyboard, mouse or touch screen, a display 444, such as, but not limited to a monitor or a Braille display, and a printer 446. Processor 420 is also coupled to a memory 430 and may execute instructions to perform at least one function of the present embodiment.

In the present embodiment, a creator user uses creator device 410 to communicate with custom system device 210, shown in FIG. 2, through a communication network, for example, without limitation, the Internet. As used herein, a “creator user” is a direct or indirect user of creator device 410 for purposes of defining, new or existing, product information and, in present embodiment, creator user information, record sets defined through, and stored in, the custom system device 210. It should be noted that, in the present invention, a consumer may be a product's creator user. Moreover, in present embodiment, creator device(s) and retail device(s), may display typical GUI menu lists of selected products, herein defined by creator users through, and stored in, custom system device 210, which makes them available, for example, without limitation, for controlled data access, by creator users, retail users and/or consumers. Such “product(s)” listed in a product menu listing may be herein understood to be “food menu product(s)”. In present embodiment a creator user signs-on to a Web site to interact with a GUI that allows users to define product information through custom system device 210 for storage therein.

A creator user may use creator device 410 to communicate with custom system device 210, shown in FIG. 2, through a communication network such as, but not limited to, the Internet, to access real time retailer information data, for example, without limitation, from retailer database 600, process database 700, ingredient database 800 and packaging database 900, all shown in FIG. 2. The creator user may then define product identifier and product description information for storage through the system for near real time access by system users, so as to allow, for example, without limitation, the near real time manufacture and/or sale of the product at retail location(s) and editing of product information stored in the custom system. In the present embodiment, a creator user may, in real time with up to date retailer information made available through the system, define a product for near real time product information availability through the system at retail location(s) providing information regarding a product, and in the identification, manufacture and sale of a product order placed at said retailer by said creator user or other consumer.

In the present embodiment, printer 446 is an optional element. If creator device 410 does not have printer 446 attached, a creator or consumer user may write down product information, or store it in creator device 410 or another device, such as, but not limited to, a storage medium such as, but not limited to a “portable device” for example, without limitation, a PDA, smart phone, a smart card, or other portable storage media or device such as a CD-ROM, USB RAM or hard drive. For example, without limitation, the creator user may write down a product identifier for communication upon order placement at a retail location, or download product information and/or retailer information, such as for example, without limitation, a list of retail location(s) where a desired product may be made available, or listings of selected product descriptions, to a portable device, in order to, for example, without limitation, be allowed to in the future establish a wireless data link connection or other data link connection to a retail device, or other communication-enabled retail location system, to exchange information such as, without limitation, product information data in a standard data file format, or to communicate with a retail operator by means of a given portable device's visual display, sound and/or data communication capabilities, and compatible communication means available at a selected retail location, for example, without limitation, upon order placement or product-related inquiry or reply.

If printer 446 is available, creator user may use creator device 410 to print product identifier and/or product description information for presentation upon order placement at selected retail location(s). For example, without limitation, a printer 446 may be used via creator device 410 to print product identifier and/or product description information, such as, but not limited to, a product name, a bar code, or other symbol, for future transmittal by a consumer placing a product order at a retail location for a product defined through custom system device 210, shown in FIG. 2.

FIG. 5 is a block schematic diagram of an exemplary retail device 510 in accordance with an embodiment of the present invention. Retail device 510 comprises a processor 520 coupled to a communication port 540, an input device 542, such as, but not limited to, a keyboard, mouse or touch screen, a display 544, such as, but not limited to a monitor or a Braille display, and a printer 546. In the present embodiment, printer 546 is an optional element, system users, such as potential consumers, may receive necessary information via display 544 or another device, such as, but not limited to, a consumer's PDA or cell phone screen, instead of, or, if 546 is present, additionally to, a printout from printer 546. Processor 520 is also coupled to a memory 530 and may execute instructions to perform at least one function of the present embodiment.

A retail user uses retail device 510 to communicate with custom system device 210, shown in FIG. 2 through a communication network, for example, without limitation, the Internet. As used herein, a “retail user” is a user of retail device 510. In the present embodiment, a retail user may interact with a GUI that allows users data access to information through custom system device 210, shown in FIG. 2, such as, but not limited to, retailer information or product information regarding a product defined through custom system device 210. A “retail operator” herein identifies all human and/or machine retailer agents involved in providing information, manufacture and/or sale of a product defined through the custom system, such as retail location staff, systems and/or devices). It should be noted that while, by definition, a retail user is always a “retail operator” and a retail operator is a system user, not every retail operator interacts with retail device 510 and so not every retail operator fits the definition herein of a retail user. Since a consumer may interact directly, or indirectly with retail device 510 via, for example, without limitation, a portable device, a consumer is, while interacting with retail device, by definition, a retail user. Those skilled in the art will recognize that a retail device 510, may also be used to display, to consumer or other retail user, a menu listing of selected products made available through the system at selected retail location(s), in order to enable, for example without limitation, product information analysis or order placement. In present embodiment, the product information and related retailer information data associated to products defined through and stored in the custom system can be further accessed and processed to be made available to selected system users, such as but not limited to consumers and other retail users via a, potentially near real time, online or offline, GUI product menu listing.

In the present embodiment, a retail user may use retail device 510 to communicate with custom system device 210, shown in FIG. 2 through a communication network such as, but not limited to, the Internet to for example, receive product description information from product database 1100, shown in FIG. 2. This information may be related to a product identifier transmitted by a consumer upon order placement at a retail location. For example, without limitation, a consumer may simply tell the retail user the product identifier for a product defined online, and a retail user may input the product identifier supplied to input device 542 and, in turn, have retail device 510 retrieve real time corresponding product description information through custom system device 210, shown in FIG. 2, for output to display 544 and/or printer 546 or other integrated systems to allow real time product identification, manufacture and/or sale.

In an alternative embodiment, the consumer may store product information and/or user information in a portable device, for example, without limitation, a PDA, smart phone or a smart card, for future transmittal of the product identifier and/or description from portable device to retail device 510 upon order placement by means of wireless data transmission such as, but not limited to, an IR communication link to a standard IR data receptor linked to retail device processor 520.

Alternatively, as noted by the dashed line in FIG. 5, processor 520 of retail device 510 could be linked to, and functionally integrated in, a standard POS device, such as, but not limited to, a POS controller 550 coupled to a number of POS terminals 560 for communication with custom system device 210, shown in FIG. 2. POS terminal 560 may comprise a card reader to read cards such as, but not limited to, cards with bar codes to record information or magnetic strip cards that have magnetically activated strips or surfaces on which data can be recorded. One such card reader is the OMNI® model 3750 payment terminal, manufactured by VeriFone, Inc., which includes a built-in magnetic-stripe reader and an integrated smart card reader, both of which may be used by a consumer to transmit information to retail operator, such as, without limitation, a valid product description and/or identifier for product order placement. In the present embodiment, a consumer may communicate the desired product identifier for input to POS terminal 560 for retrieval of real time product description information through custom system device 210, shown in FIG. 2, for real time identification, manufacture and/or sale of a product ordered. In one embodiment, retail device 510 may be the POS controller, in which case, processor 520 can be directly linked to POS terminals 560. Further integration with standard or custom manufacturing automation systems, or with other transactional systems, is also possible. Those skilled in the art will understand that devices in communication with each other need not be continually transmitting to each other. On the contrary, such devices need only transmit to each other as necessary, and may actually refrain from exchanging data most of the time. For example, without limitation, a device in communication with another device via the Internet may not transmit data to the other device for weeks at a time.

As used herein, “system users” are users, such as, without limitation, retailers, consumers, retailer users, creator users, and retail operators, that interact directly or indirectly with custom system device 210, shown in FIG. 2, by defining or using information defined through custom system device 210. Retailer users may define retailer information, creator users make use of retailer information to define product information, consumers make use of product information to place an order for a product in the system, and retail operators, such as retail users, make use of product and retailer information to validate and fulfill orders, and such information is stored in the system.

Retailer information stored in custom system device 210, shown in FIG. 2, may, in one embodiment, be stored in retailer database 600, process database 700, ingredient database 800 and packaging database 900, shown in FIG. 2, and collectively referred to as the “retail database” or “retailer databases”. Herein, the “retailer items databases” are process database 700, ingredient database 800 and packaging database 900.

FIG. 6 is a tabular representation of a portion of an exemplary retailer database 600 that may be stored in custom system device 210, in accordance with an embodiment of the present invention. Retailer database 600 may be used by custom system device 210, shown in FIG. 2, to store or retrieve retailer information. In particular, retailer database 600 may store retailer information, such as, but not limited to, identifiers, descriptions and contact information regarding retailers, including, without limitation, retail location(s).

In the present embodiment, retailer database 600 includes, but is not limited to, entries for each participating retailer's retail location(s) and corresponding retailer items set(s) usually available for the definition and manufacture of products. The data of an entry may generally be input, for example, without limitation, to the custom system before a creator user defines a product. Retailer database 600 defines a retailer identifier field 610, a retailer name field 620, a retailer description field 630, a retailer location field 640, and a retailer email field 650. The fields specify a retailer identifier field 610 that uniquely identifies a participating retailer; retailer name field 620 that uniquely identifies one or more retailer items set usually available at selected retail location(s) listed in same record in retailer description field 630 that identifies a participating retailer's retail location s name; retailer location field 640 that identifies a retail location's contact information; and retailer email field 650 that identifies more retailer contact information. Those skilled in the art will understand that retailer database 600, as well as the other tables discussed herein, may include any number of entries and fields.

Custom system device 210, shown in FIG. 2, may use retailer database 600 to determine the availability of a product at a participating retailer by relating retailer database 600 information to that in product database 1100, shown in FIG. 11 via for example, without limitation, similar contents in retailer identifier fields 610 and 1112.

Custom system device 210, shown in FIG. 2, may use retailer database 600 to determine which retailer items are currently available for any participating retailer's retail location(s) by relating the information in retailer database 600 to the information in the retailer items databases via a similar identifier, for example, without limitation, the similar contents in retailer identifier fields 610, 710, 810 and 910, shown in FIGS. 6, 7, 8, and 9 respectively. As shown in FIG. 6, each unique retailer identifier field 610 entry identifies a record in which a retailer name field 620 identifies a participating retailer for example, without limitation, “STARBUCS” and its retailer items set, which may herein identify a retailer items set that is compatible with all the participating retailer's listed retail locations, as identified by the term “STARBUCS” in retailer name 620 data entries listed in FIG. 6, and their corresponding retail location set listed in retailer location 640 data entries listed in FIG. 6.

Custom system device 210, shown in FIG. 2, may use retailer database 600, for example, without limitation, to determine which retail location(s) may be currently available for consumers to place orders for products defined in reference to a particular retailer items set. In the present embodiment, retailer identifier field 610 identifies a retailer with retailer items set(s) information defined in retailer name field 620, for example, without limitation, “STARBUCS REGION X”. For example, without limitation, “MY LATTE 13” is defined in reference to the “STARBUCS REGION X” retailer items set. Each retailer database 600 record with the same contents in retailer name field 620, for example, without limitation, “STARBUCS REGION X”, indicates the existence of a retail location sharing in such set of retailer items, which means that “MY LATTE 13” can be ordered for sale at three participating retail locations specifically identified in retailer description field 630, “RETAIL LOCATION 1”, “RETAIL LOCATION 2” and “RETAIL LOCATION 3”. Retailer location field 640 (STREET B, TOWN Q, STREET C, TOWN P, and STREET D, TOWN N) and retailer email field 650 (STARBUCSX1@ATT.COM, STARBUCSX2@ATT.COM, and STARBUCSX3@ATT.COM) are fields listed in retailer database 600. Furthermore, the text “X” and “Z” in the entry “STARBUCS REGION X,Z” may, for example, without limitation, be used by the custom system to determine the availability of products defined according to the two retailer items sets referred to by such text, “STARBUCS REGION X” and “STARBUCS REGION Z”.

Moreover, if no contents are listed for retailer location field 640, as in FIG. 6 records with retailer identifier field 610 entries “1” and “7”, this may mean that other retail location entries with common retailer name field 620 entry text, for example, without limitation, “STARBUCS”, in fact share a common set of retailer items identified by retailer description field 640 entries, for example, without limitation, “STARBUCS CHAIN”. For example, without limitation records with retailer identifier field 610 contents “2” through “6” indicate retail locations that are able to accept orders for products defined through custom system in reference to “STARBUCS CHAIN” retailer items set.

FIG. 7 is a tabular representation of a portion of an exemplary process database 700 that may be stored in the custom system device 210, shown in FIG. 2, in accordance with an embodiment of the present invention. Process database 700 may be used by custom system device 210 to store or retrieve retailer information, such as, but not limited to, the retailer items that a participating retailer makes available for use in the definition and manufacture of products. In particular, process database 700 may store retailer items information, such as, but not limited to, identifiers, descriptions and pricing information regarding product manufacturing process retailer items.

In the present example, process database 700 includes entries for participating retailer's retail location(s) and their corresponding retailer items set(s)'s manufacturing process item(s) usually available for the definition, identification, manufacture and/or sale of products through custom system device 210, shown in FIG. 2. The data of an entry may generally be input, for example, without limitation, to the custom system before a creator user defines a product. Process database 700 defines fields representing a retailer identifier field 710, a process identifier field 720, a process description field 730, a process measure field 740, and a process price field 750. Retailer identifier field 710 uniquely identifies a participating retailer for which a process item is defined. Process identifier field 720 uniquely identifies each manufacturing process item. Process description field 730 identifies a participating retailer's process item name. Process measure field 740 identifies a standard unit for measurement of a process entry. Process price field 750 identifies a cost to consumer of using a participating retailer's process item on a defined product description.

Custom system device 210 may use process database 700, for example, without limitation, to determine which retailer items information to post to creator device 410, shown in FIG. 4, after a creator user selects a participating retailer from retailer database 600, shown in FIG. 6. Custom system device 210 relates retailer database 600 records to those in the retailer process database 700 via similar contents in retailer identifiers 710 and 610 entries.

FIG. 8 is a tabular representation of a portion of an exemplary ingredient database 800 that may be stored in custom system device 210, shown in FIG. 2, in accordance with an embodiment of the present invention. Ingredient database 800 may be used by custom system device 210, shown in FIG. 2, to store or retrieve retailer information, such as, but not limited to, the retailer items that a participating retailer makes available for use in the definition and manufacture of products. In particular, ingredient database 800 may store retailer items information, such as, but not limited to, identifiers, descriptions and pricing information regarding product manufacturing ingredient retailer items.

In the present example, ingredient database 800 includes entries for participating retailer's retail location(s) and corresponding retailer items set(s)'s manufacturing ingredient item(s) usually available for the definition, identification, manufacture and/or sale of products through the custom system device 210, shown in FIG. 2. The data of an entry may generally be input, for example, without limitation, to the custom system before a creator user defines a product. Ingredient database 800 defines, in this example, a retailer identifier field 810, an ingredient identifier field 820, an ingredient description field 830, an ingredient measure field 840, an ingredient serving field 850, and an ingredient price field 860. Retailer identifier field 810 uniquely identifies a participating retailer for which an ingredient item is defined. Ingredient identifier field 820 uniquely identifies each manufacturing ingredient item. Ingredient description field 830 identifies a participating retailer s ingredient item name. Ingredient measure field 840 identifies a standard unit for measurement of an ingredient item entry. Ingredient serving field 850 identifies the quantity, in standard units, for one serving of ingredient item entry. Identification may be absolute as listed in ingredient serving field 850, or it may be relative to the packaging selected for a product, as noted by the term “PACKAGING” in field contents, and in which case the price indicated in ingredient price field 860 for the same entry can be understood to be a cost per standard unit listed for same entry record. In one embodiment, the ingredient price field 860 identifies the cost to a consumer of using a participating retailer's ingredient item on a product description manufactured and sold to consumer. In another embodiment, the cost listed in ingredient price field 860, as well as in other retailer databases' “price” field entries, could be used in the system as a basis for calculation of, for example, without limitation, the actual price to a consumer ordering a product with such item listed in product description Such calculation could for example, without limitation, consist of the addition of different price markups to price basis for different retail locations according to selected factors, such as, but not limited to, geographic location or particular Web site where a product is ordered by consumer or defined by creator user.

Custom system device 210, shown in FIG. 2, may use ingredient database 800, for example, without limitation, to determine which, if any, retailer item information to post to creator device 410, shown in FIG. 4 after a creator user selects one or more retailer items set(s) and/or retail location(s) from retailer database 600, shown in FIG. 6. Custom system device 210 may determine retailer item information to post by relating retailer database 600 records to records in ingredient database 800 via, for example, without limitation, similar contents in retailer identifier fields 810 and 610.

FIG. 9 is a tabular representation of a portion of an exemplary packaging database 900 that may be stored in custom system device 210, in accordance with an embodiment of the present invention. Packaging database 900 may be used by custom system device 210 to store or retrieve retailer information, such as, but not limited to, the retailer items usually available for the definition, identification, manufacture and/or sale of products through the custom system device 210, shown in FIG. 2. In particular, packaging database 900 may store retailer items information, such as, but not limited to, identifiers, descriptions and pricing information.

In the present example, packaging database 900 includes entries for each participating retailer s retail location(s) and corresponding retailer items set(s)' manufacturing packaging items. The data of an entry may be generally input to the custom system before a creator user defines a product. Packaging database 900 defines a retailer identifier field 910, a packaging identifier field 920, a packaging description field 930, a packaging measure field 940, a packaging size field 950, and a packaging price field 960. Retailer identifier field 910 uniquely identifies a participating retailer for which a packaging item is defined. Packaging identifier field 920 uniquely identifies each manufacturing packaging item. Packaging description field 930 identifies a participating retailer's packaging item name. Packaging measure field 940 identifies a standard unit for measurement of a packaging entry. Packaging size field 950 identifies a size associated with the packaging entry. Packaging price field 960 identifies a cost to consumer for use of a retailer's packaging item on a defined product description.

Custom system device 210, shown in FIG. 2 may use packaging database 900, for example, without limitation, to determine which retailer items information to post to creator device 410, shown in FIG. 4, after a creator user selects a participating retailer from retailer database 600, shown in FIG. 6. Custom system device 210 may determine what information to post by relating records in retailer database 600 to records in retailer items packaging database 900, for example, without limitation, via similar contents in retailer identifier fields 910 and 610.

FIG. 10 is a tabular representation of a portion of an exemplary user database 1000 that may be stored in the custom system device 210, shown in FIG. 2, in accordance with an embodiment of the present invention. User database 1000 may be used by custom system device 210 to store or retrieve user information, such as, but not limited to, information related to a system user. In particular, user database 1000 may store user information, such as, but not limited to, identifiers, descriptions and contact information regarding system users such as, for example, without limitation, creator users.

In the present example, user database 1000 includes entries for system users. For example, without limitation, if required by the system in a standard user registration process, the data of an entry may generally be input, for example, without limitation, to the custom system before a creator user defines a product. User database, 1000 defines a user identifier field 1010, a user name field 1020, a user email field 1030, a user zip code field 1040, a user gender field 1050, and a user notes field 1060. User identifier field 1010 uniquely identifies a user. User name field 1020 identifies a user name. User email field 1030 contains a user s email contact information. User zip code field 1040 identifies user address contact information and zip code for use, for example, without limitation, in retailer's promotions or consumer demographic statistics studies. User gender field 1050 identifies the gender of the user. User notes field 1060 identifies more user information, such as, but not limited to, allergies, health information, or dietary preferences. In embodiments of the present invention used in other industries, this user information may include an almost limitless number of possible types of information, for example, without limitation, type of system user, body sizes for product fit such as clothing sizes, color preferences, previously purchased items, demographics, medical, nutritional, or otherwise individual notes, needs or preferences, etc.

Custom system device 210, shown in FIG. 2, may use user database 1000, for example, without limitation, to determine if a given listed creator user has product information in product database 1100, refer to FIG. 11. Custom system device 210 determines this by relating the records in user database 1000 to records in product database 600, shown in FIG. 6, via, for example, without limitation, similar contents in user identifier fields 610 and 1111. Custom system device 210 may also determine if a creator user has input an email address information for future contact by checking the contents of user email field 1030.

FIG. 11 is a tabular representation of a portion of an exemplary product database 1100 that may be stored in custom system device 210, shown in FIG. 2, in accordance with an embodiment of the present invention. Product database 1100 may be used by custom system device 210, shown in FIG. 2, to store or retrieve information about a product defined through custom system device 210. In particular, product database 1100 may include product information necessary for the identification, manufacture and/or sale of a product at selected retail location(s), such as, but not limited to, identifiers, descriptions and pricing information regarding products defined by creator users.

In the present example, product database 1100 includes entries for each manufacturing step required by a product description defined through custom system device 210, shown in FIG. 2. The data of an entry may generally be input, for example, without limitation, to the custom system before a consumer orders the product to which the entry pertains. Product database 1100 defines a product identifier field 1110, a user identifier field 1111, a retailer identifier field 1112, a production step field 1113, a process identifier field 1114, an ingredient identifier field 1115, an ingredient quantity field 1116, and a packaging identifier field 1117. Product identifier field 1110 uniquely identifies a product. User identifier field 1111 identifies a user. Retailer identifier field 1112 identifies a participating retailer. Production step field 1113 uniquely identifies the production of a product in a sequence of steps describing the manufacture of a product identified by similar contents in product identifier field 1110. Process identifier field 1114 identifies a manufacturing process item. Ingredient identifier field 1115 identifies one or more manufacturing ingredient item(s) that are part of a production step and are therein associated to other ingredient item(s) listed in ingredient identifier field 820 in the same record, see FIG. 8, or in a previous production step field 1113, see FIG. 11. Ingredient quantity field 1116 identifies a quantity relative to an ingredient item listed in ingredient identifier field 1115 in the same record. Packaging identifier field 1117 identifies a manufacturing packaging item.

A product description such as, but not limited to, the one represented by “MY LATTE 13” in product database 1100, can be generated or interpreted through custom system device 210, shown in FIG. 2, using different methods. In one method, the retailer items set used as reference in a product description defined through the custom system can be identified by the contents of retailer identifier field 1112 in product database 1100. “MY LATTE 13” has a record entry “2” in retailer identifier 1112 for the current example of product database 1100, which, according to similar contents in retailer identifier field 610, shown in FIG. 6, identifies the record information in retailer name field 620 as “STARBUCS REGION X”. “MY LATTE 13” is therefore defined in reference to the “STARBUCS REGION X” retailer items set listed in retailer name field 620, shown in FIG. 6. Furthermore, each record from retailer database 600, shown in FIG. 6, with similar contents in retailer name field 620, for example, without limitation, “STARBUCS REGION X”, indicates a retail location sharing this set of retailer items. This means that “MY LATTE 13” can be ordered for sale at three participating retail locations specifically identified in retailer description field 630, shown in FIG. 6. These three locations, according to the present example, are “RETAIL LOCATION 1”, “RETAIL LOCATION 2” and “RETAIL LOCATION 3” These locations are further described by the content in other fields in the same record, such as, but not limited to, the contents of retailer identifier field 610, which is “2”, “3”, and “4” for the three locations, retailer location field 640, which are “STREET B, TOWN Q”, “STREET C, TOWN P”, and “STREET D, TOWN N” for the three locations, and retailer email field 650, which are respectively “STARBUCSX1@ATT.COM ”, “STARBUCSX2@ATT.COM ”, and “STARBUCSX3@ATT.COM” for the three retail locations.

In an alternate exemplary method, the retail location(s) where a product is usually available for manufacture and/or sale can be identified by the contents of retailer identifier fields 710, 810, or 910 referred in FIGS. 7, 8 and 9, with similar entries in retailer identifier 610, in FIG. 6, and listed in the present example as the entry “1”, which is meant to identify all retail location(s) listed for the participating retailer chain “STARBUCS” in FIG. 6. So, that according to present example and alternate method, all “STARBUCS” retail locations would be able to provide the product “MYLATTE13”.

In the present example, the product description information comprises a set of manufacturing specifications that may be represented by a sequence of steps each to be populated by one or more retailer items and related parameters as selected and is input through custom system device 210, shown in FIG. 2, and stored in product database 1100. All production steps listed in product database 1100 for a given product description are related by a similar product identifier, for example, without limitation, “MY LATTE 13”, listed in product identifier field 1110. Each production step for each product description may be modeled in and represented by a singular record in product database 1100. The production steps may be referred to via their unique identifiers in production step field 1113 because each production step is indicated by a different number in production step field 1113. The production step identifier listed in production step field 1113 is unique within the set of record(s) describing one product with similar contents in product identifier field 1110 and represents an individual production step. Each production step may be described in relation to retailer information (in present example in databases, 600, 700, 800 and 900, shown respectively in FIGS. 6, 7, 8, and 9) and indicated by uppercase letters in ingredient identifier field 1115. Production steps may also be described in relation to the ingredient item result from a previous production step(s), which are herein indicated by numbers in ingredient identifier field 1115. The production step information used to define or manufacture a product can be identified in reference to the contents of each different production step field 1113 for each product. For example, without limitation, and as described below, product database 1100 can, with its fields and their relationships to other tables in the system, contain the information necessary to effectively model and represent the production steps for “MY LATTE 13” from product database 1100.

The instructions represented by “1” in production step field 1113 are as follows, according to the present example. Mix half serving of nonfat organic milk with half serving of vanilla soymilk in work container. The work container is represented by “1” in packaging identifier field 1117 and further described in the corresponding record in packaging database 900, shown in FIG. 9. Mix is a process represented by “1” in process identifier field 1114 and process description field 720, shown in FIG. 7, and further described, for example without limitation, by “MIX” in process description field 730, also shown in FIG. 7. The ingredient “NONFAT ORGANIC MILK” is represented by “A” in ingredient identifier field 820, shown in FIG. 8, and ingredient identifier field 1115, and further described in ingredient description field 830, shown in FIG. 8, and the ingredient “VANILLA SOY MILK” is represented by “B” in ingredient identifier field 820, shown in FIG. 8 and ingredient identifier field 1115, and further described in ingredient description field 830, shown in FIG. 8. The instructions indicate to mix the ingredients in standardized quantities, represented by contents of “½” in ingredient quantity field 1116, which means 50% of the serving listed for an ingredient, such as, but not limited to, “A” or “B”, in ingredient serving field 850, shown in FIG. 8. As indicated by the contents “PACKAGING” in ingredient serving field 850, shown in FIG. 8, the serving amount is relative to the packaging size of the item identified by “2” in packaging identifier fields 1117 and 920, shown in FIG. 9, represented by a packaging size field 950 of “12” and packaging measure field 940 of “FLUID OUNCES”, both shown in FIG. 9. In the present example, when the serving amount listed in a product description is relative to the packaging size, the custom system may automatically deduct a number of fluid ounces to allow space for other ingredients, such as, but not limited to, the espresso, foam and other toppings for the present example. Therefore, a retail operator responsible for product description implementation would know to mix an amount of ingredients relative to the product packaging size and discount, for example, without limitation, two ounces from total milk mix, to allow sufficient space in packaging for the other ingredients in the product, as determined through the system or reasonably by retail operator. Therefore the instructions are to mix 4 fluid ounces of “VANILLA SOY MILK” with 4 fluid ounces of “NONFAT ORGANIC MILK” for a “PAPER CUP MEDIUM” packaged product. While as shown above in the present example, the listing of “PACKAGING” as the contents in ingredient serving field 850, shown in FIG. 8, indicates an ingredient quantity relative to a selected packaging size, alternatively, as shown below in another example, the amount of any one ingredient to be used in a manufacturing process may be directly represented in the contents of ingredient measure field 840 and ingredient serving field 850, shown in FIG. 8, for measurement units and a quantity listed.

In the present example, the instructions represented by the contents “2” in production step field 1113 are as follows. Mix 3.5 grams of espresso ground beans with 3.5 grams of decaf espresso ground beans in work container. The work container is represented by the contents of “1” packaging identifier field 1117 and further described in the corresponding record in packaging database 900, shown in FIG. 9. Mix is a process represented by “1” in process identifier fields 1114 and 720, shown in FIGS. 11 and 7 respectively, and further described by “MIX” in process description field 730, shown in FIG. 7. The ingredient “EXPRESSO SHOT” is represented by “C” in ingredient identifier fields 1115 and 820, shown in FIGS. 11 and 8 respectively, and further described in ingredient description 830, also shown in FIG. 8, and the ingredient “EXPRESSO SHOT DECAF” is represented by “D” in ingredient identifier fields 1115 and 820, shown in FIGS. 11 and 8, and further described in ingredient description 830, shown in FIG. 8. The instructions indicate to mix the ingredients in standardized quantities, represented by the contents of “½” in ingredient quantity field 1116, which means 50% of the serving listed for an ingredient, such as, but not limited to, “C” or “D”, in ingredient serving field 850, shown in FIG. 8. As indicated by the contents “7” in ingredient serving field 850 and the contents “GRAMS” in ingredient measure field 840, both shown in FIG. 8, the serving amount is standardized for espresso shots (decaf or regular), so that a retail operator supplied with sufficient product description information would know to mix 3.5 grams of espresso decaf ground coffee with 3.5 grams of espresso ground coffee into an appropriate container for the next step, “BREW ESPRESSO”, which is a process description field 730 entry that could, reasonably or automatically, indicate the type of container for the 7 grams powder mix to go in.

In the present example, the instructions represented by the contents “3” in production step 1113 are as follows. Brew espresso shot with ingredients mixed in production step “2”, described above. Brew is a process represented by the contents “4” in process identifier fields 1114 and 720, shown in FIGS. 11 and 7, and further described by the contents “BREW EXPRESSO” in process description field 730, shown in FIG. 7. The ingredient item result(s) of a previous production step is represented by numbers in ingredient identifier field 1115, which herein is the “2” listed in ingredient identifier field 1115.

The instructions for the record “4” listed in production step field 1113 are as follows, according to the present example. Steam milk ingredients mixed in production step “1” above. Steam is a process represented by “2” in process identifier fields 1114 and 720, shown in FIGS. 11 and 7, and further described by the contents “STEAM 130F” in process description field 730, shown in FIG. 7. It should be noted that for creator users or consumers interested in hotter beverages, in present example, without limitation, such preference could be expressed by an optional selection of the usually available “STEAM 15OF” during the product description's customization by a creator user or alternatively by real time modification upon order placement. The result from “1”, the previous production step field 1113, is the milk mix. As noted above, the result of a previous production step is represented by its number, which herein is the “1” listed in ingredient identifier field 1115 for production step “4”.

In the present example, the instructions represented by the contents “5” in production step field 1113 are as follows. Mix steamed milks with espresso shot in medium sized paper cup. The instructions further indicate to mix 90%, represented by “ 9/10” in ingredient quantity field 1116, of the milk mix result from production step “4” above, and the full espresso mix shot resulting from production step “3” above, represented by “1” in ingredient quantity field 1116, in appropriate packaging, which is represented by the contents of “2” in packaging identifier field 1117 and further described by the record “2” in similar packaging identifier field 920, shown in FIG. 9, as a “PAPER CUP MEDIUM in packaging size field 950, shown in FIG. 9, of 12 fluid ounces in size as described in packaging size field 950 and packaging measure field 940 shown in FIG. 9.

The instructions represented by “6” in production step field 1113, shown in FIG. 11, are as follows, according to the present example. Apply 10% of the milk mix foam resulting from production step “4” above as topping to packaged mix result from step “5”. The amount of 10% is represented by the contents of “ 1/10” in ingredient quantity field 1116 and the foam from production step “4” above is listed in ingredient identifier field 1115. The topping is represented by “6” in process identifier fields 1114 and 720, shown in FIGS. 11 and 7, and further described by “TOPPING BY WEIGHT”, which is the process description field 730 for the record with an entry of “6” in process identifier field 720, both shown in FIG. 7. The foam topping is added to the result from production step “5”, which is the medium sized paper cup packaging already containing the steamed milks and espresso shot mix result from previous steps, as indicated by the record entry “S5” in packaging identifier field 1117, where the “S” in the “S5” entry identifies a previous record's field production step 1113 and the number “5” in “S5” identifies such production step number.

The instructions represented by the record entry “7” in production step field 1113 are as follows, according to the present example. Apply ingredient toppings and lid. Packaging identifier field 1117 lists S6, 8”, which indicates the toppings are to be applied to the already packaged result from production step “6”, which is the medium sized paper cup containing the steamed milks, espresso shot mix plus foam, indicated by the record entry “S6” in packaging identifier field 1117, and a lid, indicated by “8” in the packaging identifier fields 1117 and 920, shown in FIGS. 11 and 9, respectively, and further described by “LID-PAPER CUP MEDIUM”, which is the packaging description field 930 entry, shown in FIG. 9, for the record entry “6” in process identifier field 720, shown in FIG. 7, which is to be supplied to a consumer upon product sale or applied to packaging in manufacture. The ingredient toppings to be applied at the end of product manufacture are listed as “E, F, G” in ingredient identifier fields 1115 and 820, shown in FIGS. 11 and 8, respectively, and further described by “WHIPPED CREAM SPRAY”, “CINNAMON” and “SUGAR” in ingredient description field 830, shown in FIG. 8, in ingredient quantities “1, 1, 2”, listed in ingredient quantity field 1116, shown in FIG. 11 Such quantities are listed in ingredient quantity field 1116 in relation to the ingredient measure 840 and ingredient serving field 850 record entry listed for ingredient identifier fields 1115 and 820 “E”, “F” and “G” entries, shown in FIGS. 11 and 8. So that a retail operator supplied with product description information would know to apply the following toppings: one 2-second spray of whipped cream, 0.01 ounces of cinnamon and, finally, 0.2 ounces of sugar. The amount of topping in this example is indicated by the record entry “5” in process identifier field 1114, which represents “TOPPING BY TIME” as indicated in process identifier field 720, shown in FIG. 7.

In the present embodiment, custom system device 210, shown in FIG. 2, may use product database 1100, for example, without limitation, to determine availability of a product at a given retail location by relating the information in product database 1100, shown in FIG. 11 to the information in retailer database 600, shown in FIG. 6, via similar contents in retailer identifier fields 610 and 1112 to find the retail location(s) listed in retailer database 600. This use of the system could be prompted by a system user's GUI action(s), upon, for example, without limitation, input of a product identifier at a retailer in order to determine its validity at a given retail location, or to determine its cost to consumer at a given retail location.

“System devices” such as client devices, shown in FIGS. 3, 4 and 5, and through them any integrated or linked devices or systems, such as the POS system, shown in FIG. 5, or a consumer's portable device, herein discussed but not shown in FIGs, and the custom system device 210, shown in FIG. 2, may further access product database 1100, shown in FIG. 11, for example, without limitation, to determine a price for a product by adding the values listed in process price field 750, shown in FIG. 7, ingredient price field 860, shown in FIG. 8, and packaging price field 960, shown in FIG. 9, relative to the quantity of each retailer item in a product, for all retailer items identified in a product description such as, but not limited to those shown in the records of product database 1110. According to the present example, without limitation, adding up the prices listed for the retailer items in “MY LATTE 13” in product database 1100, the system can determine the following costs. The packaging cost is $0.37, calculated by adding the contents of packaging price field 960 for each unique packaging item identified in packaging identifier field 1117 ($0.30+$0.07). The processing cost is $0.80, calculated by adding the contents of process price field 750 for each process item identified in process identifier field 1114 ([“MIX”: $0.05×3]+[“STEAM 150F”: $0.15]+[“BREW EXPRESSO”: $0.3]+[“TOPPING BY TIME”: $0.05]+[“TOPPING BY WEIGHT”: $0.05×3]). The ingredient cost is $0.49, calculated by adding the contents of ingredient price field 860 for each ingredient item identified in ingredient identifier field 1115 ([“A”through “G”]) and relative to item ingredient quantity field 1116 ([“A”: $0.05×0.5]+[“B”: $0.07×0.5]+[“C”: $0.15×0.5]+[“D”: $0.15×0.5]+[“E”: $0.05]+[“F”: $0.01]+[“G”: $0.01]). Such calculated costs, and other information stored in custom system device 210 may be further used by the system or system users to determine, directly or indirectly, a final product price to a consumer, or cost to participating retailer or retail location.

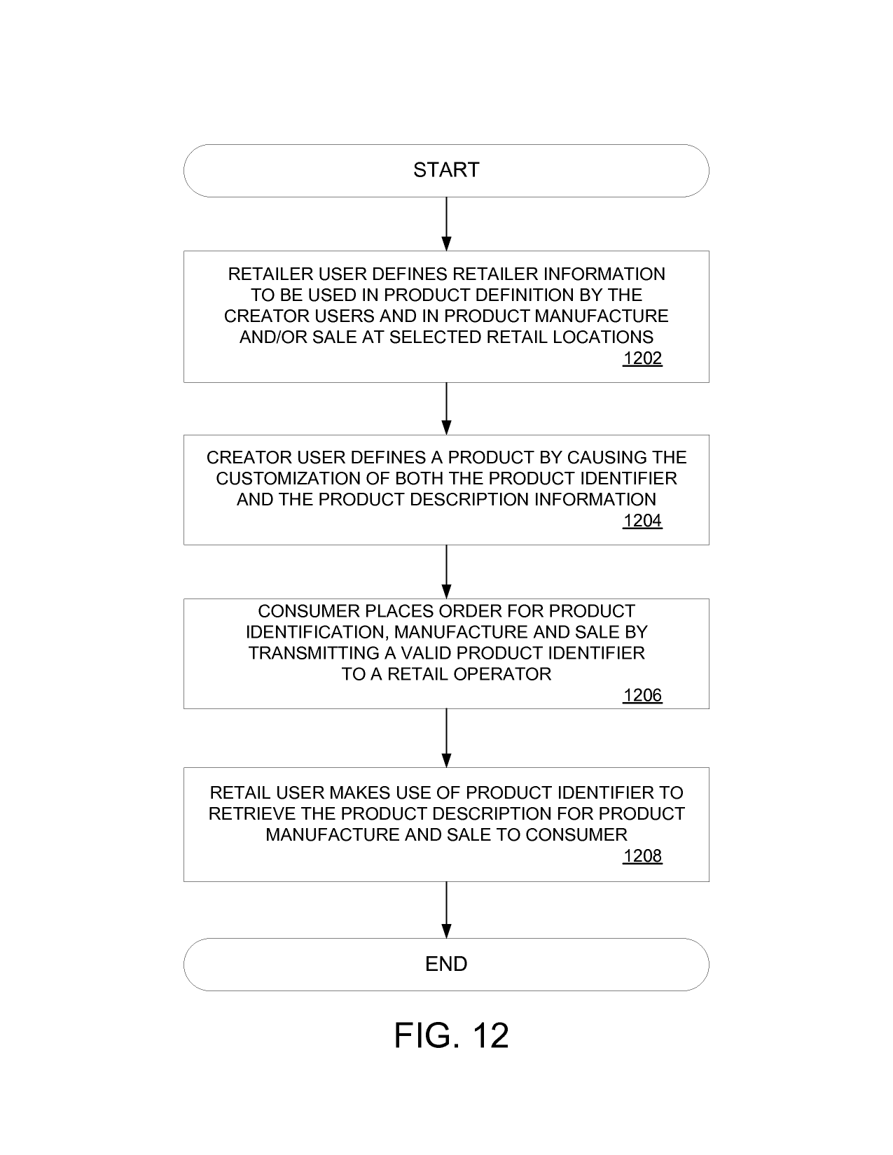

FIG. 12 is a flow chart illustrating an exemplary method in which a consumer places a product order with a retailer for a product defined using a communication network, in accordance with an embodiment of the present invention.

In present embodiment's exemplary implementation, the method starts at step 1202 where a retailer user defines retailer information, and the custom system device 210 stores the retailer information, for future controlled access by system users and devices, for example, without limitation, in product definition by creator users and in product manufacture and/or sale at retail location(s). In step 1204, a creator user defines a product by causing the customization of the product identifier and corresponding product description aspects of the product information record set, and the custom system device 210 stores the product information for future controlled access, potentially in real time, by system users. In step 1206, a consumer places a product order at a retail location for near real time identification, manufacture and sale of a product by transmitting a valid product identifier information to a retail operator. In step 1208, a retail user inputs the valid product identifier supplied by the consumer, and in turn the retail operator accesses and retrieves sufficient corresponding valid product description information, and the necessary related retailer information, from system databases such as, but not limited to, those stored in custom system device 210, shown in FIG. 2, to allow the manufacture and sale of the product ordered at the selected retail location.

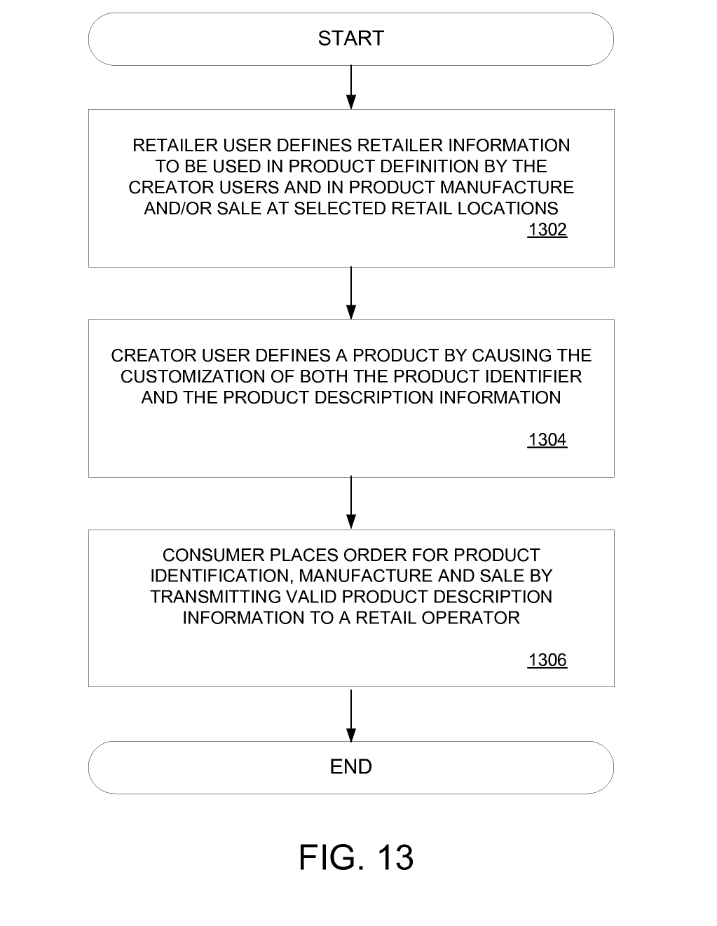

FIG. 13 is a flow chart illustrating an exemplary method in which a consumer places a product order with a retailer for a product defined using a communication network, in accordance with an embodiment of the present invention.

In present embodiment's exemplary implementation, the method starts at step 1302 where a retailer user defines retailer information, and the custom system device 210 stores the retailer information, for future controlled access by system users and devices, for example, without limitation, in product definition by creator users and in product manufacture and/or sale at retail location(s). In step 1304, a creator user defines a product by causing the customization of the product identifier and corresponding product description aspects of the product information record set, and the custom system device 210 stores the product information for future controlled access, potentially in real time, by system users. Finally, in step 1306, a consumer places a product order at a retail location for near real time identification, manufacture and sale of a product by transmitting a valid product description information to a retail operator.

According to methods of use described in reference to FIGS. 12 and 13 in steps 1202 and 1302, a retailer user interacts with retailer device 310, shown in FIG. 3, to communicate with custom system device 210, shown in FIG. 2, through a communication network, for example, without limitation, the Internet, to define the retailer information. The retailer defines retailer information by populating the record entries of the retail database with at least one set of retailer items and one set of retail location information that will be used for future, potentially near real time, access by system users, such as, but not limited to, creator users for the customization of products based on real time retailer information stored in the retail database of custom system device 210 using a communication network, for example, without limitation, through the Internet.

As noted, above, in an alternative embodiment not described herein, the function of retailer devices and retailer users in the custom system may be replaced by the data import of the necessary retailer information to custom system device 210, shown in FIG. 2, from a data source other than retailer device 310, shown in FIG. 3.

If retailer information previously used as a basis for product definitions through the system is thereafter changed, the existing product descriptions based on the changed retailer information may become unavailable. In such case, system users may be informed and further advised of possible item alternatives, for example, without limitation, in a GUI screen popup message during product definition or product order placement and/or in an email sent by custom system device 210 to the email listed in user email field 1030, refer to FIG. 10, for a creator user that inputted such contact information during a typical user registration process. In a typical user registration process, according to the present embodiment, data input may be required from a user before access is allowed to particular system features, such as, but not limited to, the definition of products through custom system device 210. For example, without limitation, depending on data collected during user registration, such as in typical opt-out or opt-in GUI action selections, the custom system may communicate via email mailings that may be sent to selected system users upon events, such as, but not limited to, creator users during a promotional campaign, retailer or retail users upon definition of a new product based on a retailer s retailer items set(s), or to creator users upon changes to existing retailer information that may impact existing product information.

As described above in step 1204, referring to FIG. 12, and step 1304, referring to FIG. 13, a creator user interacts with creator device 410, shown in FIG. 4, to define products by causing the customization of both the product identifier and the product description, which is defined in terms of at least one set of retailer items and selected creator user GUI action. This product information is then stored as a record set in custom system device 210 in product database 1100, shown in FIG. 11, by using a communication network, for example, without limitation, the Internet. In some applications the creator user may use a browser application window to sign-on to the custom system Web site. In this example, the sign-on action may comprise the input of a Web site address through the browser GUI by the creator user. In some applications, the sign-on may also comprise the input of user information. User registration may be required before a creator user is allowed to further interact with the system at any phase of interaction with the system, such as, but not limited to, before a creator user is allowed to define a new product. The creator user may go through a standard user registration process, during which custom system device 210 may send traditional user registration questions to the browser GUI, and receive the creator user data entry replies as input for storage in a record created for each registered user in custom system device 210 to be stored in a database such as, but not limited to, user database 1000, shown in FIG. 10.

After successfully signing-on to the Web site in the present embodiment, the creator user is ready to start defining a new or existing product through the custom system. A creator user may be required to directly or indirectly identify existing product information stored in custom system for further edit through custom system via GUI action. Or a creator user may be required to directly or indirectly, enter and/or select a customized valid product identifier, and select at least one set of retailer items(and its related retailers, usually available for the placement of product orders, and product information requests, by consumers) to be associated with a new product definition via GUI action. Custom system device 210, shown in FIG. 2, may communicate with creator device 410, shown in FIG. 4, to post and display a list of automatically generated valid product identifier options for individual selection by a creator user, or to get and validate a customized product identifier entered into a data screen area such as a HTML textbox by a creator user via GUI action. Custom system device 210, shown in FIG. 2, may communicate with creator device 410, shown in FIG. 4, to post and display a list of participating retailers and their retailer items set(s) in a GUI for the creator user to select at least one set of retailer items for use in the definition of a product through custom system device 210. For example, without limitation, a standard HTML list box dynamically populated with all retailer names from retailer name field 620 in retailer database 600, shown in FIG. 6, may be used for selection of a retailer items set by the creator user through GUI(s) action. After the creator user successfully selects one set of retailer items, custom system device 210 may communicate with creator device 410 to dynamically display related retailer information for use in the definition of a product description through custom system device 210. In another example, without limitation, one or more sets of retailer items may be displayed by default to a system user by the system, and further selected, for example, without limitation, according to items' availability at selected retail location(s), retailer(s), geographical area(s), selected retailer items and/or selected retail location(s)' price point or price ranges, and/or according to other query options allowed by system databases and GUIs' features, as understood by those skilled in the art and instructed in present embodiment's description.

The information in a set of records in product database 1100, shown in FIG. 11, depicting the manufacturing steps of a product, may be graphically represented, for example, without limitation, on a client device GUI, by screen objects depicting a timeline or other layout sequence of manufacturing steps to be populated with retailer items entries and their related parameters information as selected and otherwise inputted by creator user GUI action during the definition of a product through the custom system device 210. The creator user may be required to select and/or define a sequence of manufacturing steps, and to define each step in relation to retailer items' manufacturing processes and associated materials and related parameters, and/or in relation to previous production step(s) results. The system may, at any point in the product definition's process, provide creator users with a choice to customize and automatically select, propose, randomize, or revert to default settings, any individual and/or associated aspects of the GUI's product definition's processes and data. So that a creator user, may for example, without limitation, request via GUI action that retailer items displayed as potential basis for a product's definition be limited to those appropriate to a diabetic, or other customized diet, or further to dynamically request proposals by a software wizard on how to complete any aspects of the product definition process implemented through the creator device GUI.

Other product definition system features may include, without limitation, the display, through custom system device 210, shown in FIG. 2, of a GUI that allows a creator user to select a product template, such as, but not limited to, a Latte Template, which could cause the dynamic display, for example, without limitation, of a default manufacturing timeline template depicting a product description with a default number of steps such as, but not limited to, the steps and processes listed in the “MY LATTE 13” product description in FIG. 1 on creator device 510, shown in FIG. 5, for possible further customization of steps and associated items, such as, but not limited to, retailer items, by the creator user. The creator user could, for example, without limitation, be required only to select ingredient items to populate or edit a selected displayed template's sequence of manufacturing steps and associated retailer items and parameters, to define a valid product description. The definition of a product that starts with the selection and editing of a product template via GUI action by a creator user, may still allow the same flexibility in the customization of a product description as if no product template had been first selected through custom system device 210. The custom system may also allow for the definition and storage of product templates customized by creator user, for example, without limitation, for different types of coffee beverages in a coffee house retailer.

In some applications, a creator user may want to change an existing product description that may have been defined by another user through custom system device 210, shown in FIG. 2. Such creator user may, after a successful sign-on, type a valid product identifier on a GUI textbox for input to the system, and, in turn, have the custom system post the corresponding product description to a GUI that may allow modification and upload of complete product information record set to product database 1100, shown in FIG. 11, via creator user GUI action. Such creator user may, after a successful sign-on, be allowed to point to, and select, an existing food menu product displayed on a GUI menu listing, and to associate said selected product's product description to a new customized product identifier so as to complete the definition of a new product, with the same, or further customized, said selected product description, through custom system device 210.

When a consumer order is placed with a product identifier as shown in step 1206 of FIG. 12, the consumer transmission of product information upon order placement at retail location may take place, for example, without limitation, by the oral or written communication of an alphanumeric product identifier, such as, but not limited to, “MY LATTE 13”, at a retail location to a retail operator, which may be a retail user or a retail device 510, or therein data linked and/or integrated devices and systems.

Upon transmission of a product identifier at a retail location, the retail user may input the product identifier into the custom system via retail device in step 1208 of FIG. 12, and a retail user GUI action can cause the transmission of product information, including, but not limited to, the product identifier, to custom system device 210, shown in FIG. 2. In turn, the system retrieves the product identifier s corresponding product description stored, for example, without limitation, in product database 1100, shown in FIG. 11, and posts it to, or outputs it through, retail device 510, and to other data linked and/or integrated devices and systems, so as to provide retail users, and any linked automated manufacturing systems, with sufficient information to allow the manufacture and/or sale of product ordered at the selected retail location.

In some embodiments, a consumer may also cause the transmission of product information between a portable device such as, but not limited to, a PDA, smart phone or a smart card, and retail device 510, shown in FIG. 5, for example, without limitation, for order placement (step 1206 in FIG. 12 or step 1306 in FIG. 13). The consumer may also use the portable device to provide information for automatic order payment, via a wireless data link between a PDA and retail device 510, or other appropriate means.

In present embodiment, selected system users such as a consumer may interact with selected client devices 310, 410 and/or 510 display of a GUI product menu listing of creator-user-defined products information stored in system databases, and to search through selected information stored in the system, such as but not limited to product information and related retailer information. Such system users may further select and format the informational content and/or appearance of said GUI product menu listing according to factors such as, for example without limitation, the product being available at one or more selected retail location(s) and/or geographical areas, type of product, serving size, ingredient(s) listed in product(s) description, total calories, price, and/or preparation time, that can be identified through the custom system device 210 system databases.

When a product order is placed with a product description in step 1306, referring to FIG. 13, the consumer places an order for manufacture and/or sale of a product by transmitting sufficient product information, including, but not limited to, product description information, at a retail location. Product information submitted by a consumer at a retail location may be input into retail device 510, shown in FIG. 5, for validation through the custom system in order to, for example, without limitation, ensure the acceptability of sale price by a consumer, and/or the compatibility of a selected retail location with the retailer items used in the product definition through the custom system device 210, shown in FIG. 2. Generally, the response of the custom system to user input of a product identifier and/or a product description upon, for example, without limitation, product order placement, may include, without limitation, system validation of user input, for example, without limitation, for verification of existence of the product information in product database 1100, upon order placement, or for verifying the validity of a product description and/or product identifier in terms, for example, without limitation, of a particular retail location's ability to identify, provide information regarding, manufacture and/or sell a product, to impose constraints such as establishing independent price markups or discounts to the prices supplied through the custom system device 210, or to require system user age identification, for example, for alcohol sales, or a local membership signup, or to offer product add-ons and/or product alternatives, all potentially in near real time with the product definition and/or product order placement. In the present embodiment, if a product identifier and/or product description are not found in the system, or if the retailer items available at a selected retail location are not compatible with the retailer items referred to in product description, the product order will not be accepted, and product alternatives may be offered through the system.

The custom system validation of the system user input and the system's Web-application dynamic reaction to a system user GUI action may, for example, without limitation, prompt automatic system action, such as, but not limited to, sending system information to one or more system devices and/or system users. This information may be emailed to a registered system user by making use of the information in user email field 1030 of the user database 1000, shown in FIG. 10. In other cases, a user may be contacted through other information that may be contained in user database 1000 such as, but not limited to, the user's contact address and/or phone number.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like.

Having fully described at least one embodiment of the present invention, other equivalent or alternative methods of implementing a method and system for consumers to place orders for products defined using a communication network, according to the present invention, will be apparent to those skilled in the art. The invention has been described above by way of illustration, and the specific embodiments disclosed are not intended to limit the invention to the particular forms or components disclosed therein. The invention is thus to cover all modifications, equivalents, and alternatives falling within the spirit and scope of the following claims.

What is claimed is:

1. A method for defining a food menu product over a communications network, and ordering thereof by a consumer, the method comprising the Steps of:
defining retailer information associated with a retailer, said retailer information being stored as a retailer record set in a local or remote retail database, said retailer record being populated with at least one set of retailer items and one set of retail location(s); and
a consumer defining, over said communications network, a food menu product based at least in part on a product identifier and said retailer information and product description information, said product definition being stored as a product record set in a product database and operable for use in matching a food menu product order placed by a consumer with the sufficiently corresponding food product identifier and/or product description information to identify the food menu product, and enabling the manufacture and/or sale of said matched product order at retail location(s) offering compatible retailer items or product alternatives.

2. The method of claim 1, further comprising the Steps of:
presenting the consumer at said retail location(s) with an opportunity to communicate said product identifier and/or product description information to a retail operator for the purpose of placing a product order or to exchange with said retail operator information associated with said food;
registering a product order based on at least one product selected by the consumer; and
transmitting to the retailer that sells said available product a valid product identifier and/or product description information associated with said ordered product, said transmitted order providing sufficient product information for said retailer to identify, manufacture and/or sell, or otherwise provide, said ordered product to the consumer.

3. The method of claim 2, further comprising the Steps of:
said retailer that sells said product receiving said sufficient product order information;
accessing and searching said product database and matching said product order with a corresponding product record set in said product database at least in part based upon said product identifier; and
said retailer that received said product order receiving at least a portion of said corresponding product record set and manufacturing, in near real time, the corresponding ordered product for said consumer that ordered the product.

4. The method of claim 2, in which the Step of presenting is performed over an intranet or the Internet using an interactive graphical user interface (GUI) displayed on a display accessible by a user of said method.

5. The method of claim 4, in which said displaying lists selected food menu product(s)' near real time product information and/or related retailer information to a user of said method.

6. The method of claim 3, further comprising the Step of displaying a sequence of manufacturing steps and parameters required to manufacture said ordered product.

7. The method of claim 2, in which said transmitting is performed by an electronic, oral, sound, written, visual, machine readable pattern, and/or biometric reading, communication of said product identifier and/or product description information.

8. The method of claim 2, in which said transmitting is performed by the consumer via the transmission of product information between a communication device associated with the consumer and said retail operator.

9. The method of claim 1, further comprising the Step of registering consumer or any other system user as a requirement to provide said retail or to use said method and said databases.

10. The method of claim 1, in which said product defining further comprises the Step of defining and storing a sequence of manufacturing steps and/or parameters required to manufacture and/or sell said product, each defined step being optionally defined in relation to retailer items' manufacturing processes and associated materials, and/or to previous production step(s) results.

11. The method of claim 1, further comprising the Steps of:
defining at least one product template that is usable for defining a certain product, said at least one product template being pre-populated with a useful, and optionally default, set of associated product option, parameters, processes, materials, and/or manufacturing steps, which product template is operable as a valid product definition or is suitable for further completion by certain system users including a consumer; and
displaying a GUI that allows a consumer performing said product defining to select and use said at least one product template as a basis for defining said product.

12. The method of claim 11, in which said product template is defined at least in part based on an existing product definition record in said product database.

13. The method of claim 2, further comprising the Steps of:
in response to said product order, validating said product order as existing in said product database and available at said retail location; and
if said product order is found to be invalid, not accepting said product order and optionally automatically prompting the consumer to select from available alternatives.

14. A method for defining a food menu product over a communications network, and ordering thereof by a consumer, the method comprising:
Steps for defining and storing retailer information associated with a participating retailer; and
Steps for defining and storing a food menu product definition that is at least in part based on said retailer information.

15. The method of claim 14, further comprising:
Steps for presenting the consumer at one of said retail location(s) with at least some products stored in said food menu product definition storage Steps that are indicated as available at said retail location;
Steps for registering a product order based on at least one product selected by the consumer; and
Steps for transmitting to the retailer that sells said available product sufficient product information for said retailer to identify, manufacture and sell, or otherwise provide, said ordered product to the consumer.

16. The method of claim 15, further comprising:
Steps for said retailer that sells said product receiving said sufficient product order information;
Steps for finding a product definition in said product database that corresponds to said product order; and
Steps for said retailer that received said product order receiving said corresponding product record set and manufacturing and selling, in near real time, the corresponding ordered product for said consumer that ordered the product.

17. The method of claim 16, further comprising Step for displaying a sequence of manufacturing steps and/or parameters required to manufacture and/or sell said ordered product.

18. The method of claim 14, in which said product defining further comprises Step for defining and storing a sequence of manufacturing steps and/or parameters required to manufacture and sell said product.

19. The method of claim 14, further comprising:
Steps for defining at least one product template; and
Steps for displaying a GUI that allows a consumer performing said product defining to select and use said at least one product template as a basis for defining said product.

20. The method of claim 15, further comprising:
in response to said product order, Steps for validating said product order as existing in said product database and being available at said retail location; and
if said product order is found to be invalid, Steps for not accepting said product order and optionally automatically notifying the consumer of alternatives.
